(19) United States
(12) Patent Application Publication
(10) Pub. No.: US 2025/0322410 A1
(43) Pub. Date: Oct. 16, 2025

(54) METHODS, APPARATUSES AND COMPUTER PROGRAM PRODUCTS FOR GENERATING CONTEXTUALIZED USER INTERFACES IN AN INTEGRATED SERVICE AND ASSET COMPUTING PLATFORM

(71) Applicant: ATLASSIAN PTY, LTD., Sydney (AU)

(72) Inventors: Andrea Leanne Olrich, Sydney (AU); Bradley Jay Schoone, Perth (AU); Christopher Charles Mann, Sydney (AU); Shiveen Pandita, Melbourne (AU); Gabriel David Tonin Raubenheimer, Sydney (AU); Vincent Chi-Kit Wong, Sydney (AU); Lauren Jessica Bradley, Sydney (AU)

(21) Appl. No.: 19/248,966

(22) Filed: Jun. 25, 2025

Related U.S. Application Data
(63) Continuation of application No. 18/620,403, filed on Mar. 28, 2024.

(51) Int. Cl. G06Q 30/015; G06F 9/451; G06Q 10/0631

(52) U.S. Cl. CPC G06Q 30/015; G06F 9/451; G06Q 10/06316

(57) ABSTRACT

Various examples herein described are directed to methods, apparatuses, and computer program products for generating contextualized user interfaces (including, but not limited to, contextualized support ticket user interfaces, allocated support seeker organization overview user interfaces, allocated support seeker organization context user interfaces, allocated support seeker contact overview user interfaces, and allocated support seeker contact context user interfaces) in complex network computer systems such as, but not limited to, integrated service and asset computing platforms.

### CROSS-REFERENCE TO RELATED APPLICATIONS

This application is a continuation of and claims priority to U.S. Non-Provisional application Ser. No. 18/620,403, filed Mar. 28, 2024, the contents of which are incorporated herein by reference in its entirety.

### BACKGROUND

Applicant has identified many technical deficiencies and problems associated with generating user interfaces in complex network computer systems.

### BRIEF SUMMARY

In general, embodiments of the present disclosure provide methods, apparatuses, systems, computing devices, and/or the like for generating contextualized user interfaces in complex network computer systems such as, but not limited to, integrated service and asset computing platforms.

In accordance with various embodiments of the present disclosure, an apparatus is provided. In some embodiments, the apparatus comprises at least one processor and at least one non-transitory memory comprising program code. In some embodiments, the at least one non-transitory memory and the program code are configured to, with the at least one processor, cause the apparatus to at least: receive a contextualized support ticket visualization request from a support provider computing device; access a support ticket data object from a ticket-based service managing system based at least in part on the support ticket identifying metadata; access a support seeker data object from an asset-based data tracking system based at least in part on the support seeker identifying metadata; and cause generating a contextualized support ticket user interface on the support provider computing device. In some embodiments, the contextualized support ticket visualization request comprises support ticket identifying metadata. In some embodiments, the support ticket data object comprises support seeker identifying metadata. In some embodiments, the support seeker data object comprises support seeker context metadata. In some embodiments, the contextualized support ticket user interface comprises a support seeker context user interface component based at least in part on the support seeker context metadata.

In some embodiments, the contextualized support ticket user interface comprises a support ticket description user interface component displayed adjacent to the support seeker context user interface component.

In some embodiments, the support seeker context metadata comprises customer context metadata.

In some embodiments, the support seeker context user interface component comprises a customer context metadata user interface element based at least in part on the customer context metadata.

In some embodiments, the at least one non-transitory memory and the program code are configured to, with the at least one processor, cause the apparatus to: receive an allocated support seeker organization visualization request from the support provider computing device; access one or more support seeker data objects from the asset-based data tracking system based at least in part on the support provider identifying metadata; and cause generating an allocated support seeker organization overview user interface on the support provider computing device based at least in part on the one or more support seeker data objects. In some embodiments, the allocated support seeker organization visualization request comprises support provider identifying metadata.

In some embodiments, the allocated support seeker organization overview user interface comprises an allocated organization tabular user interface component.

In some embodiments, the at least one non-transitory memory and the program code are configured to, with the at least one processor, cause the apparatus to: receive an allocated support seeker contact visualization request from the support provider computing device; access one or more support seeker data objects from the asset-based data tracking system based at least in part on the support provider identifying metadata; and cause generating an allocated support seeker contact overview user interface on the support provider computing device based at least in part on the one or more support seeker data objects. In some embodiments, the allocated support seeker contact visualization request comprises support provider identifying metadata.

In accordance with various embodiments of the present disclosure, a computer-implemented method is provided. In some embodiments, the computer-implemented method comprises: receiving a contextualized support ticket visualization request from a support provider computing device; accessing a support ticket data object from a ticket-based service managing system based at least in part on the support ticket identifying metadata; accessing a support seeker data object from an asset-based data tracking system based at least in part on the support seeker identifying metadata; and causing generating a contextualized support ticket user interface on the support provider computing device. In some embodiments, the contextualized support ticket visualization request comprises support ticket identifying metadata. In some embodiments, the support ticket data object comprises support seeker identifying metadata. In some embodiments, the support seeker data object comprises support seeker context metadata. In some embodiments, the contextualized support ticket user interface comprises a support seeker context user interface component based at least in part on the support seeker context metadata.

In accordance with various embodiments of the present disclosure, a computer program product is provided. In some embodiments, the computer program product comprises at least one non-transitory computer-readable storage medium having computer-readable program code portions stored therein. In some embodiments, the computer-readable program code portions comprise an executable portion configured to: receive a contextualized support ticket visualization request from a support provider computing device; access a support ticket data object from a ticket-based service managing system based at least in part on the support ticket identifying metadata; access a support seeker data object from an asset-based data tracking system based at least in part on the support seeker identifying metadata; and cause generating a contextualized support ticket user interface on the support provider computing device. In some embodiments, the contextualized support ticket visualization request comprises support ticket identifying metadata. In some embodiments, the support ticket data object comprises support seeker identifying metadata. In some embodiments, the support seeker data object comprises support seeker context metadata. In some embodiments, the contextualized support ticket user interface comprises a support seeker context user interface component based at least in part on the support seeker context metadata.

The foregoing illustrative summary, as well as other exemplary objectives and/or advantages of the disclosure, and the manner in which the same are accomplished, are further explained in the following detailed description and its accompanying drawings.

### BRIEF DESCRIPTION OF THE DRAWINGS

Having thus described some embodiments in general terms, references will now be made to the accompanying drawings, which are not necessarily drawn to scale.

FIG. 1 is an example system architecture diagram illustrating an example integrated service and asset computing platform in communication with other devices (such as, but not limited to, support provider computing devices, support seeker computing devices, and/or the like) in accordance with some embodiments of the present disclosure.

FIG. 2 is an example block diagram illustrating example components of an example apparatus in accordance with some embodiments of the present disclosure.

FIG. 3 is an example block diagram illustrating example components of an example apparatus in accordance with some embodiments of the present disclosure.

FIG. 4 is an example flow diagram illustrating example methods associated with generating example contextualized support ticket user interfaces in accordance with some embodiments of the present disclosure.

FIG. 5A is an example visualization view illustrating an example contextualized support ticket user interface in accordance with some embodiments of the present disclosure.

FIG. 5B is an example visualization view illustrating an example portion of an example contextualized support ticket user interface in accordance with some embodiments of the present disclosure.

FIG. 5C is an example visualization view illustrating an example portion of an example contextualized support ticket user interface in accordance with some embodiments of the present disclosure.

FIG. 5D is an example visualization view illustrating an example portion of an example contextualized support ticket user interface in accordance with some embodiments of the present disclosure.

FIG. 5E is an example visualization view illustrating an example portion of an example contextualized support ticket user interface in accordance with some embodiments of the present disclosure.

FIG. 5F is an example visualization view illustrating an example portion of an example contextualized support ticket user interface in accordance with some embodiments of the present disclosure.

FIG. 6 is an example flow diagram illustrating example methods associated with generating example allocated support seeker organization overview user interfaces in accordance with some embodiments of the present disclosure.

FIG. 7A is an example visualization view illustrating an example allocated support seeker organization overview user interface in accordance with some embodiments of the present disclosure.

FIG. 7B is an example visualization view illustrating an example allocated support seeker organization context user interface in accordance with some embodiments of the present disclosure.

FIG. 8 is an example flow diagram illustrating example methods associated with generating example allocated support seeker contact overview user interfaces in accordance with some embodiments of the present disclosure.

FIG. 9A is an example visualization view illustrating an example allocated support seeker contact overview user interface in accordance with some embodiments of the present disclosure.

FIG. 9B is an example visualization view illustrating an example allocated support seeker contact context user interface in accordance with some embodiments of the present disclosure.

FIG. 10A, FIG. 10B, FIG. 10C, and FIG. 10D are example system schema diagrams illustrating example data communications in example integrated service and asset computing platforms in accordance with some embodiments of the present disclosure.

### DETAILED DESCRIPTION OF VARIOUS EMBODIMENTS

Various embodiments of the present disclosure are described more fully hereinafter with reference to the accompanying drawings, in which some, but not all embodiments of the disclosure are shown. Indeed, the disclosure may be embodied in many different forms and should not be construed as limited to the embodiments set forth herein. Rather, these embodiments are provided so that this disclosure will satisfy applicable legal requirements. The term “or” is used herein in both the alternative and conjunctive sense, unless otherwise indicated. The terms “illustrative,” “example,” and “exemplary” are used to be examples with no indication of quality level. Like numbers refer to like elements throughout.

The term “comprising” means “including but not limited to,” and should be interpreted in the manner it is typically used in the patent context. Use of broader terms such as “comprises,” “includes,” and “having” should be understood to provide support for narrower terms such as “consisting of,” “consisting essentially of,” and “comprised substantially of.”

The phrases “in one embodiment,” “according to one embodiment,” “in some examples,” “for example,” and the like generally mean that the particular feature, structure, or characteristic following the phrase may be included in an embodiment of the present disclosure, and may be included in more than one embodiment of the present disclosure (importantly, such phrases do not necessarily refer to the same embodiment).

### Overview

Various embodiments of the present disclosure relate generally to methods, apparatuses, systems, computing devices, and/or the like for generating contextualized user interfaces in complex network computer systems such as, but not limited to, integrated service and asset computing platforms.

In the present disclosure, the term “integrated service and asset computing platform” refers to a cloud-based computing platform for delivering information technology related services and managing information technology related assets. For example, an example integrated service and asset computing platform may comprise software and associated hardware that are configured to provide information technology related services such as, but not limited to, software-based functions (including, but not limited to, user authentication functions, network gateway functions, and/or the like), software products (including, but not limited to, document collaboration software, project management software, and/or the like), and/or the like to users. Additionally, or alternatively, an example integrated service and asset computing platform may comprise software and associated hardware that are configured to monitor, track and/or support information technology related assets (including, but not limited to, user computing devices, servers, external hard drives, network attached storage, network routers, monitors, speakers, keyboards, mouses, and/or the like).

In some embodiments, an example integrated service and asset computing platform may be implemented in the context of information technology service management (ITSM). For example, one or more support seekers may utilize the example integrated service and asset computing platform to report one or more information technology related issues. Continuing in such an example, one or more support providers may utilize the example integrated service and asset computing platform to manage, track, and resolve the one or more information technology related issues, as well as managing, tracking, and supporting information technology related assets associated with the one or more support seekers.

For example, an example integrated service and asset computing platform may enable support providers to track and resolve information technology related issues such as, but not limited to, hardware issues (for example, problems related to physical components of a computing device), software issues (for example, problems related to operations of services (for example, user authentication issues) and/or software products), connectivity issues, and/or the like. Additionally, or alternatively, an example integrated service and asset computing platform may enable support providers to track and support information technology related assets such as, but not limited to, software products, software services, user computing devices, servers, external hard drives, network attached storage, network routers, monitors, speakers, keyboards, mouses, and/or the like.

In the present disclosure, the term “support seeker” refers to a user (including, but not limited to, an individual user, an organization user, and/or the like) who reports information technology related issues to one or more support providers through an example integrated service and asset computing platform and/or receives information technology related support from one or more support providers through the example integrated service and asset computing platform.

In the present disclosure, the term “support provider” refers to a user (including, but not limited to, an individual user, an organization user, and/or the like) who provides information technology related support (including, but not limited to, managing, tracking, and resolving information technology related issues, managing, tracking, and supporting information technology related assets, and/or the like) to one or more support seekers through the example integrated service and asset computing platform.

As an example, a support seeker may be an employee of Acme Corporation who tries to install a software product on a computing device owned by Acme Corporation. However, the computing device generates error messages and cannot complete an installation of the software product. In such an example, the support seeker may utilize an example integrated service and asset computing platform in accordance with some embodiments of the present disclosure to report this issue to a support provider that provides information technology related support to Acme Corporation (for example, a customer support agent). Continuing in this example, the customer support agent may utilize the example integrated service and asset computing platform to manage, track, and resolve this issue related to installing software on the computing device from Acme Corporation.

Continuing from the example above, the failure to install the software product on the computing device may result from the support seeker not owning a software license to the software product. As such, the support provider needs to obtain support seeker context metadata related to the support seeker to identify and resolve the issue.

Support seeker context metadata can be critical for support providers to provide information technology related support and resolve information technology related issues reported by support seekers. However, there are many technical problems, challenges, and difficulties associated with presenting support seeker context metadata through user interfaces to support providers due to factors such as, but not limited to, limitations associated with non-normalized data structures that are associated with many platforms. Such limitations can result in low speed, accuracy, and usability when such platforms are used in the context of ITSM.

Some support providers may attempt to incorporating context when providing information technology related support by manually matching and looking up information related to support seekers through separate systems that are external to an integrated service and asset computing platform. However, data stored in those separate, external systems is often in a non-normalized data structure that is not compatible with data structures in the integrated service and asset computing platform. In such an example, displaying such data on a user interface requires the integrated service and asset computing platform to obtain the data, normalize the data, and then render the data to a defined portion of the user interface. As a result, such approaches result in low speed and low accuracy in rendering user interfaces to provide information to support providers, and the rendering speed can be further reduced when different support seekers access different software platforms, and their data are stored in a variety of different data structures in such platforms that are external to the integrated service and asset computing platform.

Some support providers may reach out to support seekers to request or obtain context associated with the support seeker. However, a support provider may provide information technology related support to tens or hundreds (or more) support seekers that are each associated with different contexts, and manually reaching out to each support seeker can result in significant delay and errors in providing information technology related support. Continuing from the example above, a computing device from another support seeker may also generate error messages and fail to install a different software product, despite having obtained a software license for the software product. As such, a support provider cannot simply use the solution provided to one support seeker to address a similar issue reported by another support seeker. In such an example, a support provider needs to obtain support seeker context metadata associated with the support seeker who reported the issue, and may determine that the issue is caused by the software product being incompatible with the computing device of the support seeker (for example, the software product may not support the operating system on the computing device).

Various embodiments of the present disclosure overcome these technical challenges and difficulties, and provide various technical improvements in computing systems such as the integrated service and asset computing platform.

For example, to overcome those deficiencies in user interface devices, various embodiments of the present disclosure provide methods, apparatuses, systems, computing devices, and/or the like for generating contextualized support ticket user interfaces, which visualize not only data related to information technology related issues reported by support seekers, but also support seeker context metadata related to the support seekers, thereby providing context associated with the support seeker. Additionally, or alternatively, various embodiments of the present disclosure provide methods, apparatuses, systems, computing devices, and/or the like for generating allocated support seeker organization overview user interfaces and allocated support seeker organization context user interfaces, which visualize support seeker context metadata related to organizations that are allocated to a support provider for providing information technology related support. Additionally, or alternatively, various embodiments of the present disclosure provide methods, apparatuses, systems, computing devices, and/or the like for generating allocated support seeker contact overview user interfaces and allocated support seeker contact context user interfaces, which visualize support seeker context metadata related to individuals that are allocated to a support provider for providing information technology related support.

Example user interfaces in accordance with various embodiments of the present disclosure (including, but not limited to, contextualized support ticket user interfaces, allocated support seeker organization overview user interfaces, allocated support seeker organization context user interfaces, allocated support seeker contact overview user interfaces, and allocated support seeker contact context user interfaces) provide technical benefits and advantages such as, but not limited to, improving speed, accuracy, and usability associated with integrated service and asset computing platforms. For example, example user interfaces in accordance with some embodiments of the present disclosure (including, but not limited to, contextualized support ticket user interfaces, allocated support seeker organization overview user interfaces, allocated support seeker organization context user interfaces, allocated support seeker contact overview user interfaces, and allocated support seeker contact context user interfaces) enable support providers to intuitively obtain support seeker context metadata associated with support seekers (which provides context associated with the support seeker) without spending time and effort to manually look up information related to support seekers or reach out to support seekers. As such, example user interfaces in accordance with the present disclosure improve the first contact resolution rate (which is defined as the rate of successfully resolving information technology related issues when the support provider contacts the support seeker for the first time) and reduce the time to resolution (which is defined as the time it takes for a support provider to resolve information technology related issues reported by a support seeker) in integrated service and asset computing platforms.

Further, various structured user interfaces in accordance with some embodiments of the present disclosure (including, but not limited to, contextualized support ticket user interfaces, allocated support seeker organization overview user interfaces, allocated support seeker organization context user interfaces, allocated support seeker contact overview user interfaces, and allocated support seeker contact context user interfaces) may be generated based on defining new data object types such as, but not limited to, support seeker data objects. In various embodiments of the present disclose, support seeker data objects may comprise support seeker context metadata that provide context associated with the support seeker. For example, support seeker context metadata may include, but are not limited to, customer context metadata, product and service context metadata, asset context metadata, work item context metadata, organization context metadata, and contract and entitlement context metadata. In various embodiments of the present disclosure, support seeker data objects are generated by an example integrated service and asset computing platform, and stored internally in the example integrated service and asset computing platform (for example, in an asset-based data tracking system of the example integrated service and asset computing platform). As such, various embodiments of the present disclosure improve the speed and accuracy in rendering user interfaces that provide support seeker context metadata associated with support seekers (including, but not limited to, contextualized support ticket user interfaces, allocated support seeker organization overview user interfaces, allocated support seeker organization context user interfaces, allocated support seeker contact overview user interfaces, and allocated support seeker contact context user interfaces), and such user interfaces that are generated based on support seeker data objects resolve technical problems in many other platforms. Various embodiments of the present disclosure provide specific improvements to operations of integrated service and asset computing platforms by visualizing support seeker context metadata from support seeker data objects that are stored internally in the integrated service and asset computing platforms, thereby improving accuracy and speed of integrated service and asset computing platforms in rendering support seeker context metadata associated with the support seekers to the support providers.

Additional technical details highlighting these technical benefits and improvements are described further herein.

### Definitions

In the present disclosure, the terms “set,” “subset,” and similar terms refer to a collection of zero or more elements.

In the present disclosure, the terms “data,” “content,” “digital content,” “digital content object,” “information,” and similar terms may be used interchangeably to refer to data capable of being transmitted, received, and/or stored in accordance with examples of the present disclosure. Thus, use of any such terms should not be taken to limit the spirit and scope of examples of the present disclosure. Further, where a computing device is described herein to receive data from another computing device, it will be appreciated that the data may be received directly from another computing device or may be received indirectly via one or more intermediary computing devices, such as, for example, one or more servers, relays, routers, network access points, base stations, hosts, and/or the like (sometimes referred to herein as a “network”). Similarly, where a computing device is described herein to send data to another computing device, it will be appreciated that the data may be sent directly to another computing device or may be sent indirectly via one or more intermediary computing devices, such as, for example, one or more servers, relays, routers, network access points, base stations, hosts, and/or the like.

In the present disclosure, the term “circuitry” should be understood broadly to include hardware and, in some examples, software for configuring the hardware. With respect to components of the apparatus, the term “circuitry” as used herein should therefore be understood to include particular hardware configured to perform the functions associated with the particular circuitry as described herein. For example, in some examples, “circuitry” may include processing circuitry, storage media, network interfaces, input/output devices, and the like.

In some embodiments, the term “user computing device” refers to a computing device that is operated by a user entity to access an example integrated service and asset computing platform in accordance with some embodiments of the present disclosure. In some embodiments, a user entity may include individual users, organizations, enterprises, and/or the like. In some embodiments, user computing devices may include, but not limited to, desktop computers, workstations, portable digital assistant devices, mobile telephones, smartphones, laptop computers, tablet computers, wearables, or any combination of the aforementioned devices.

In some embodiments, example user computing devices may be categorized based on the type of the user entity operating the user computing device. In some embodiments, the term “support seeker computing device” refers to a computing device that is operated by a support seeker of an example integrated service and asset computing platform. In some embodiments, the term “support provider computing device” refers to a computing device that is operated by a support provider of an example integrated service and asset computing platform.

In some embodiments, the term “data object” refers to structured data that represents, provides, and/or describes information, content, functionalities and/or characteristics associated with information and/or content. In some embodiments, the term “metadata” refers to a parameter, a data field, a data element, a data attribute, a data property, and/or the like that is a part of one or more data objects, requests, responses, and/or the like. In some embodiments, example data objects and/or example metadata may be embodied in forms such as, but not limited to, binary codes, American Standard Code for Information Interchange (ASCII) codes, memory addresses or pointers to memory addresses in data storage devices, and/or the like.

In some embodiments, the term “support seeker identifying metadata” refers to metadata that uniquely identifies a support seeker of the example integrated service and asset computing platform. In some embodiments, support seeker identifying metadata may comprise an organization name, a person name, a username, a user email address, a user ID number, and/or the like. Additionally, or alternatively, support seeker identifying metadata may comprise text string(s), numerical character(s), alphabetical character(s), alphanumeric code(s), ASCII character(s), and/or the like. In some embodiments, an example integrated service and asset computing platform may assign and/or correlate unique support seeker identifying metadata to each support seeker of the example integrated service and asset computing platform.

In some embodiments, the term “support provider identifying metadata” refers to metadata that uniquely identifies a support provider of the example integrated service and asset computing platform. In some embodiments, support provider identifying metadata may comprise an organization name, a person name, a username, a user email address, a user ID number, and/or the like. Additionally, or alternatively, support provider identifying metadata may comprise text string(s), numerical character(s), alphabetical character(s), alphanumeric code(s), ASCII character(s), and/or the like. In some embodiments, an example integrated service and asset computing platform may assign and/or correlate unique support provider identifying metadata to each support provider of the example integrated service and asset computing platform.

In some embodiments, the term “support ticket data object” refers to a data object that describes information and content associated with one or more information technology related issues that are identified and/or reported by one or more support seekers and/or are managed and/or tracked by one or more support providers.

In some embodiments, an example support ticket data object may comprise metadata that includes, but not limited to, support seeker identifying metadata, support provider identifying metadata, support ticket identifying metadata, support ticket content metadata, and/or the like. For example, the support seeker identifying metadata may identify one or more support seekers who identify and/or report the information technology related issue described in the support ticket data object. Continuing this example, the support provider identifying metadata may identify one or more support providers who tracks and/or provides support to address the information technology related issue described in the support ticket data object.

In some embodiments, the term “support ticket identifying metadata” refers to metadata that uniquely identifies information and content of a support ticket data object in an example integrated service and asset computing platform. In some embodiments, each support ticket data object is associated with unique support ticket identifying metadata. In some embodiments, support ticket identifying metadata may comprise text string(s), numerical character(s), alphabetical character(s), alphanumeric code(s), ASCII character(s), and/or the like. In some embodiments, an example integrated service and asset computing platform may assign and/or correlate unique support ticket identifying metadata to each support ticket data object that is generated by and/or stored in the example integrated service and asset computing platform.

In some embodiments, the term “support ticket content metadata” refers to metadata that describes details associated with the information technology related issue described in a support ticket data object. For example, example support ticket content metadata may include information and content describing a hardware issue encountered by a support seeker. Additionally, or alternatively, example support ticket content metadata may include information and content describing a software issue encountered by a support seeker. Additionally, or alternatively, example support ticket content metadata may include information and content describing a connectivity issue encountered by a support seeker. Additionally, or alternatively, example support ticket content metadata may include information and content describing an authentication issue encountered by a support seeker. While the description above provides examples of information and content associated with example support ticket content metadata, it is noted that the scope of the present disclosure is not limited to the examples above. In some embodiments, support ticket content metadata may comprise text string(s), numerical character(s), alphabetical character(s), alphanumeric code(s), ASCII character(s), and/or the like.

In some embodiments, the term “support seeker data object” refers to a data object that describes information and content associated with one or more support seekers of an example integrated service and asset computing platform. In some embodiments, an example support seeker data object may comprise metadata that includes, but not limited to, support seeker identifying metadata, support seeker context metadata, support provider identifying metadata, and/or the like.

In some embodiments, each support seeker data object is associated with and/or comprise support seeker identifying metadata that identifies one or more support seekers. As an example, support seeker identifying metadata in a support seeker data object may identify an employee of Acme Corporation. In such an example, the support seeker identifying metadata indicates that the support seeker data object describes information and content (such as, but not limited to, support seeker context metadata) associated with the employee of Acme Corporation.

In some embodiments, each support seeker data object is associated with and/or comprise support provider identifying metadata that identifies one or more support providers. In some embodiments, the support provider identifying metadata may identify one or more support providers who are allocated to provide information technology related support to the one or more support seekers associated with the support seeker data object. As an example, support provider identifying metadata in a support seeker data object may identify a customer support agent. In such an example, the support provider identifying metadata indicates that the customer support agent provides information technology related support to the support seeker associated with the support seeker data object.

In some embodiments, the term “support seeker context metadata” refers to a category or type of metadata that describes context data and information associated with one or more support seekers (including individual users as well as organization users) of the support seeker data object. For example, example support seeker context metadata may comprise various metadata that describe various aspects of context associated with a support seeker (including, but not limited to, customer context metadata, product and service context metadata, asset context metadata, work item context metadata, organization context metadata, and contract and entitlement context metadata).

In some embodiments, the term “customer context metadata” refers to metadata that describes context information related to one or more customers associated with the support seeker. For example, the support seeker may be a customer who works for Acme Corporation. In such an example, the customer context metadata may provide data such as, but not limited to, the name of the customer, information associated with contact details of the customer, information associated with locations of the customer, information associated with customer satisfaction scores of the customer, and/or the like.

In some embodiments, the term “product and service context metadata” refers to metadata that describes data related to product and services associated with the support seeker. For example, the product and service context metadata may provide data such as, but not limited to, products entitlement information associated with the support seeker, health and incident statuses associated with one or more services that the support seeker uses, upcoming changes associated with one or more services that the support seeker uses, upcoming features associated with one or more software products that the support seeker uses, edition information associated with one or more software products that the support seeker uses, and/or the like.

In some embodiments, the term “asset context metadata” refers to metadata that describes data related to information technology related assets associated with the support seeker. For example, the asset context metadata may provide data such as, but not limited to, information associated with the one or more laptops that the support seeker uses, information associated with the one or more phones that the support seeker uses, and/or the like.

In some embodiments, the term “work item context metadata” refers to metadata that describes data related to work items associated with the support seeker. For example, the work item context metadata may provide data such as, but not limited to, information associated with previous requests that are submitted by the support provider, information associated with software features that are requested by the support provider, information associated with software bugs that are reported by the support provider, and/or the like.

In some embodiments, the term “organization context metadata” refers to metadata that describes data related to one or more organizations associated with the support seeker. For example, the organization context metadata may provide data such as, but not limited to, the name(s) of organization(s) that the support seeker is employed at or represents, information associated with industry or industries that such organization(s) are in, information associated with contact details of such organization(s), information associated with website(s) of such organization(s), information associated with customer tier of such organization(s), and/or the like.

In some embodiments, the term “contract and entitlement context metadata” refers to metadata that describes data related to contract and entitlement associated with the support seeker. For example, the contract and entitlement context metadata may provide data such as, but not limited to, information associated with contracts that are executed by the support seeker, information associated with support tier that is assigned to the support seeker, information associated with the renewal date of such contracts, information associated with the amount described in such contracts, information associated with the number of seats in such contracts, and/or the like.

As described above, an example integrated service and asset computing platform may provide information technology related services such as, but not limited to, software-based functions (including, but not limited to, user authentication functions, network gateway functions, and/or the like), software products (including, but not limited to, document collaboration software, project management software, and/or the like), and/or the like to users (including, but not limited to, support seekers). In some embodiments, the term “service data object” refers to a data object that describes information and content (such as, but not limited to, health status of the service, incidents on the service, upcoming changes associated with the service, and/or the like) associated with one or more information technology related services of an example integrated service and asset computing platform. In some embodiments, the term “service identifying metadata” refers to metadata that uniquely identifies information and content of a service data object in an example integrated service and asset computing platform. In some embodiments, each service data object is associated with unique service identifying metadata. In some embodiments, service identifying metadata may comprise text string(s), numerical character(s), alphabetical character(s), alphanumeric code(s), ASCII character(s), and/or the like. In some embodiments, an example integrated service and asset computing platform may assign and/or correlate unique service identifying metadata to each service data object of the example integrated service and asset computing platform.

As described above, an example integrated service and asset computing platform may manage information technology related assets (including, but not limited to, user computing devices, servers, external hard drives, network attached storage, network routers, monitors, speakers, keyboards, mouses, and/or the like). In some embodiments, the term “asset data object” refers to a data object that describes information and content associated with one or more assets that are managed or tracked through an example integrated service and asset computing platform. In some embodiments, the term “asset identifying metadata” refers to metadata that uniquely identifies information and content of an asset data object in an example integrated service and asset computing platform. In some embodiments, each asset data object is associated with unique asset identifying metadata. In some embodiments, asset identifying metadata may comprise text string(s), numerical character(s), alphabetical character(s), alphanumeric code(s), ASCII character(s), and/or the like. In some embodiments, an example integrated service and asset computing platform may assign and/or correlate unique asset identifying metadata to each asset data object of the example integrated service and asset computing platform.

In some embodiments, an example support seeker data object is a type of asset data object and has similar data structure as the data structure of an asset data object. In such example embodiments, the example support seeker data object may be stored within the integrated service and asset computing platform along with other asset data objects (for example, in an asset-based data tracking system of the integrated service and asset computing platform). Compared with the approaches that store data external to the integrated service and asset computing platform, various embodiments of the present disclosure improve speed in rendering user interfaces that display support seeker context metadata, additional details of which are described herein.

In accordance with various embodiments of the present disclosure, an example support provider computing device may generate and transmit various visualization requests to an example integrated service and asset computing platform to request the example integrated service and asset computing platform to cause various user interfaces to be rendered on the example support provider computing device.

For example, an example support provider computing device may generate a contextualized support ticket visualization request. In some embodiments, the term “contextualized support ticket visualization request” refers to a request to generate a contextualized support ticket user interface on the support provider computing device. In some embodiments, the contextualized support ticket visualization request comprises support ticket identifying metadata, additional details of which are described herein. In some embodiments, the term “contextualized support ticket user interface” refers to a user interface that visualizes not only metadata related to the information technology related issue reported by a support seeker, but also context metadata related to the support seeker.

For example, an example contextualized support ticket user interface may comprise one or more support ticket description user interface components that visualize data related to the information technology related issue reported by the support seeker, as well as one or more support seeker context user interface components that visualize support seeker context metadata related to the support seeker. For example, an example support seeker context user interface component may comprise one or more customer context metadata user interface elements, one or more product and service context metadata user interface elements, one or more asset context metadata user interface elements, one or more work item context metadata user interface elements, one or more organization context metadata user interface elements, one or more contract and entitlement context metadata user interface elements, and/or the like. Additional details associated with the contextualized support ticket user interfaces are illustrated and described herein.

Additionally, or alternatively, an example support provider computing device may generate an allocated support seeker organization visualization request. In some embodiments, the term “allocated support seeker organization visualization request” refers to a request to generate allocated support seeker organization overview user interfaces. In some embodiments, the term “allocated support seeker organization overview user interface” refers to a user interface that visualizes support seeker context metadata related to organizations that are allocated to a support provider. For example, an example allocated support seeker organization overview user interface may comprise one or more allocated organization tabular user interface components. Additional details associated with the allocated support seeker organization overview user interfaces are illustrated and described herein.

Additionally, or alternatively, an example support provider computing device may generate an allocated support seeker contact visualization request. In some embodiments, the term “allocated support seeker contact visualization request” refers to a request to generate allocated support seeker contact overview user interfaces. In some embodiments, the term “allocated support seeker contact overview user interface” refers to a user interface that visualizes support seeker context metadata related to contacts that are allocated to a support provider. For example, an example allocated support seeker contact overview user interface may comprise one or more allocated contact tabular user interface components. Additional details associated with the allocated support seeker contact overview user interfaces are illustrated and described herein.

### Example System Architecture for Implementing Embodiments of the Present Disclosure

Methods, apparatuses, and computer program products of the present disclosure may be embodied by any of a variety of devices. For example, example methods, apparatuses, and computer program products of example embodiments may be embodied by a networked computing device (for example, but not limited to, a network server in an example integrated service and asset computing platform). Additionally, or alternatively, example methods, apparatuses, and computer program products of example embodiments may be embodied by fixed computing devices, such as a personal computer or a computer workstation. Additionally, or alternatively, example methods, apparatuses, and computer program products of example embodiments may be embodied by any of a variety of mobile devices such as, but not limited to, portable digital assistants, mobile telephones, smartphones, laptop computers, tablet computers, wearables, or any combination of the aforementioned devices.

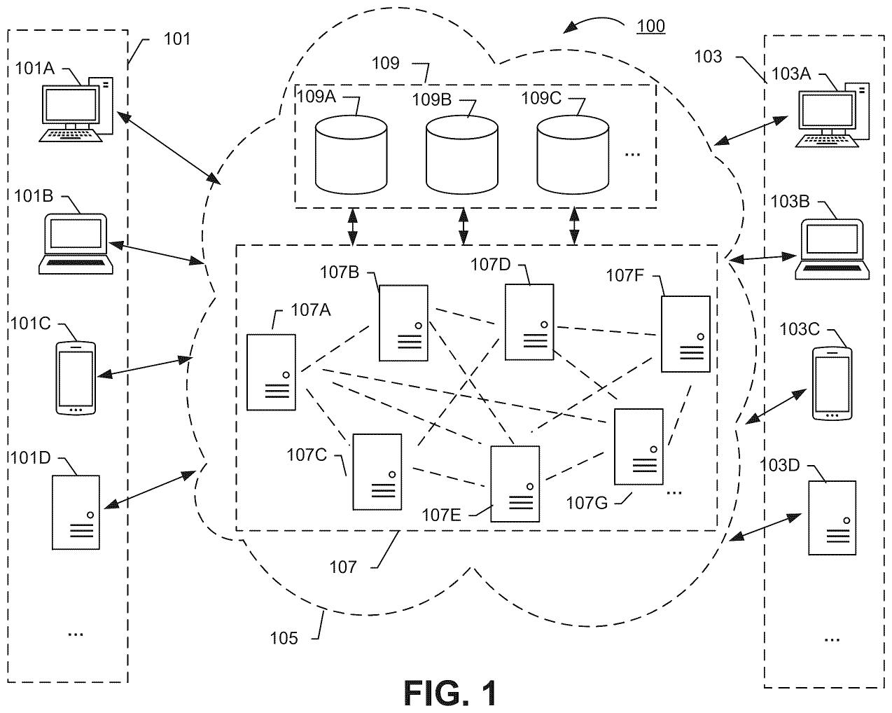

Referring now to FIG. 1, an example system architecture diagram illustrates an example cloud-based computing environment 100 within which embodiments of the present disclosure may operate.

In the example shown in FIG. 1, the cloud-based computing environment 100 may comprise an example integrated service and asset computing platform 105 in electronic communication with one or more user computing devices (such as, but not limited to, one or more support provider computing devices 101, one or more support seeker computing devices 103, and/or the like) via one or more networks (such as, but not limited to, one or more local area networks, one or more wide area networks, and/or the like).

In the example shown in FIG. 1, the one or more support provider computing devices 101 include, but are not limited to, support provider computing device 101A, support provider computing device 101B, support provider computing device 101C, and support provider computing device 101D. In some embodiments, the one or more support provider computing devices 101 may comprise computing devices including, but not limited to, desktop computers, laptop computers, smartphones, netbooks, tablet computers, wearables, servers, and the like.

In some embodiments, each of the one or more support provider computing devices 101 may be operated by a support provider of the example integrated service and asset computing platform 105. In some embodiments, each of the one or more support provider computing devices 101 may comprise, store, and/or otherwise be associated with support provider identifying metadata that identifies a support provider of the example integrated service and asset computing platform 105. For example, the support provider computing device 101A may store support provider identifying metadata that indicates the support provider computing device 101A is operated by a customer support agent, and the support provider computing device 101B may store support provider identifying metadata that indicates the support provider computing device 101B is operated by a different customer support agent.

While FIG. 1 illustrates example support provider computing devices, it is noted that the scope of the present disclosure is not limited to the example illustrated in FIG. 1. In some examples, an example integrated service and asset computing platform may communicate with less than or more than the number of example support provider computing devices illustrated in FIG. 1, and/or may additionally or alternatively comprise other types of computing devices that operate as support provider computing devices.

In the example shown in FIG. 1, the one or more support seeker computing devices 103 include, but are not limited to, support seeker computing device 103A, support seeker computing device 103B, support seeker computing device 103C, and support seeker computing device 103D. In some embodiments, the one or more support seeker computing devices 103 may comprise computing devices including, but not limited to, desktop computers, laptop computers, smartphones, netbooks, tablet computers, wearables, servers, and the like.

In some embodiments, each of the one or more support seeker computing devices 103 may be operated by a support seeker of the example integrated service and asset computing platform 105. In some embodiments, each of the one or more support seeker computing devices 103 may comprise, store, and/or otherwise be associated with support seeker identifying metadata that identifies a support seeker of the example integrated service and asset computing platform 105. For example, the support seeker computing device 103A may store support seeker identifying metadata that indicates the support seeker computing device 103A is operated by a user from Acme Corporation, and the support seeker computing device 103B may store support seeker identifying metadata that indicates the support seeker computing device 103B is operated by a user from Cyberdyne Systems that is different from Acme Corporation.

While FIG. 1 illustrates example support seeker computing devices, it is noted that the scope of the present disclosure is not limited to the example illustrated in FIG. 1. In some examples, an example integrated service and asset computing platform may communicate with less than or more than the number of the example support seeker computing devices illustrated in FIG. 1, and/or may additionally or alternatively comprise other types of computing devices that operate as support seeker computing devices.

In some embodiments, the one or more support provider computing devices 101 and the one or more support seeker computing devices 103 may communicate with the example integrated service and asset computing platform 105 though one or more data communication networks. Example data communication networks in accordance with some embodiments of the present disclosure may include, but not limited to, cable networks, public networks (e.g., the Internet), private networks (e.g., frame-relay networks), wireless networks, cellular networks, telephone networks (e.g., a public switched telephone network), or any other suitable private and/or public networks. Additionally, or alternatively, example data communication networks in accordance with some embodiments of the present disclosure may have any suitable communication range associated therewith and may include, for example, global networks, metropolitan area networks (MANs), wide area networks (WANs), local area networks (LANs), personal area networks (PANs), and/or the like. Additionally, or alternatively, example data communication networks in accordance with some embodiments of the present disclosure may include medium over which network traffic may be carried including, but not limited to, coaxial cable, twisted-pair wire, optical fiber, a hybrid fiber coaxial (HFC) medium, microwave terrestrial transceivers, radio frequency communication mediums, satellite communication mediums, or any combination thereof, as well as a variety of network devices and computing platforms/systems provided by network providers or other entities. Additionally, or alternatively, example data communication networks in accordance with some embodiments of the present disclosure may utilize a variety of networking protocols including, but not limited to, transmission control protocol/internet protocol (TCP/IP) based networking protocols, custom protocols of JavaScript Object Notation (JSON) objects sent via a WebSocket channel, JSON over remote procedure call (RPC), JSON over representational state transfer/hypertext transfer protocol (REST/HTTP), and/or the like.

In some embodiments, the example integrated service and asset computing platform 105 may comprise one or more network computing devices 107 and one or more data storage devices 109.

In the example shown in FIG. 1, the one or more network computing devices 107 may include, but are not limited to, network computing device 107A, network computing device 107B, network computing device 107C, network computing device 107D, network computing device 107E, network computing device 107F, and/or network computing device 107G. In some embodiments, each of the one or more network computing devices 107 may receive data from and/or transmit data to one or more other network computing devices of the one or more network computing devices 107 and/or one or more support provider computing devices 101 and/or one or more support seeker computing devices 103, additional details of which are described herein.

In some embodiments, the one or more network computing devices 107 may comprise computing devices including, but not limited to, network servers (such as, but not limited to, web servers, proxy servers, virtual machines, file transfer protocol (FTP) servers, application servers, file servers, and/or the like), cloud computing networks (including, but not limited to, private cloud computing networks, public cloud computing networks, hybrid cloud computing networks, and/or the like), mainframe computers, desktop computers, laptop computers, and/or the like.

While FIG. 1 illustrates example network computing devices, it is noted that the scope of the present disclosure is not limited to the example illustrated in FIG. 1. In some examples, an example integrated service and asset computing platform may comprise less than or more than the number of example network computing devices illustrated in FIG. 1, and/or may additionally or alternatively comprise other types of computing devices that operate as network computing devices 107.

In some embodiments, the one or more network computing devices 107 are in electronic communications with the one or more data storage devices 109. In some embodiments, the one or more network computing devices 107 may generate one or more data objects, transmit one or more data objects to the one or more data storage devices 109 for storage, and/or access one or more data objects from the one or more data storage devices 109, additional details of which are described herein.

In the example shown in FIG. 1, the one or more data storage devices 109 may include, but are not limited to, data storage device 109A, data storage device 109B, and data storage device 109C. In some embodiments, the one or more data storage devices 109 may comprise data storage devices including, but not limited to, network data storages (such as, but not limited to, directly attached storage (DAS), network attached storage (NAS), storage area network (SAN), and/or the like), local data storages (such as, but not limited to, random access memory (RAM), hard disk drive (HDD), solid-state drive (SSD), and/or the like), removable data storages (such as, but not limited to, portable hard drives), database servers, and/or the like.

While FIG. 1 illustrates example data storage devices, it is noted that the scope of the present disclosure is not limited to the example illustrated in FIG. 1. In some examples, an example integrated service and asset computing platform may comprise less than or more than the number of example data storage devices illustrated in FIG. 1, and/or may additionally or alternatively comprise other types of data storage devices that operate as data storage devices.

In accordance with various embodiments of the present disclosure, the example integrated service and asset computing platform 105 may receive one or more requests from one or more user computing devices (such as, but not limited to, one or more support provider computing devices 101, one or more support seeker computing devices 103, and/or the like). In some embodiments, based on the one or more requests from the one or more user computing devices, the example integrated service and asset computing platform 105 may generate and/or access one or more data objects, and/or may cause rendering of one or more user interfaces based on the one or more requests and the one or more data objects.

For example, in some embodiments, the example integrated service and asset computing platform 105 may receive a contextualized support ticket visualization request from a support provider computing device (for example, from the support provider computing device 101A). In such an example, the contextualized support ticket visualization request may comprise support ticket identifying metadata that uniquely identifies information and content of a support ticket data object stored in the example integrated service and asset computing platform 105 (for example, in the data storage device 109A of the example integrated service and asset computing platform 105). In such an example, the example integrated service and asset computing platform 105 may access the support ticket data object from the data storage device based at least in part on the support ticket identifying metadata. Continuing in this example, the support ticket data object may comprise support seeker identifying metadata that identifies a support seeker of the integrated service and asset computing platform 105 (for example, a support seeker operating the support seeker computing device 103A). In such an example, the example integrated service and asset computing platform 105 may access a support seeker data object from a data storage of the example integrated service and asset computing platform 105 based on the support seeker identifying metadata. As described above, the support seeker data object may comprise support seeker context metadata. In some embodiments, the example integrated service and asset computing platform 105 may cause generating a contextualized support ticket user interface on the support provider computing device 101A based at least in part on the support seeker context metadata of the support seeker data object. Additional details are described herein.

Additionally, or alternatively, in some embodiments, the example integrated service and asset computing platform 105 may receive an allocated support seeker organization visualization request from a support provider computing device (for example, from the support provider computing device 101A). In some embodiments, the allocated support seeker organization visualization request may comprise support provider identifying metadata that identifies a support provider of the example integrated service and asset computing platform 105 (for example, the support provider who operates the support provider computing device 101A). In such an example, the example integrated service and asset computing platform 105 may access one or more support seeker data objects that are associated with the support provider identifying metadata, and may cause generating an allocated support seeker organization overview user interface on the support provider computing device 101A based at least in part on the one or more support seeker data objects. Additional details are described herein.

Additionally, or alternatively, in some embodiments, the example integrated service and asset computing platform 105 may receive an allocated support seeker contact visualization request from a support provider computing device (for example, from the support provider computing device 101A). In some embodiments, the allocated support seeker contact visualization request may comprise support provider identifying metadata that identifies a support provider of the example integrated service and asset computing platform 105 (for example, the support provider who operates the support provider computing device 101A). In such an example, the example integrated service and asset computing platform 105 may access one or more support seeker data objects that are associated with the support provider identifying metadata, and may cause generating an allocated support seeker contact overview user interface on the support provider computing device 101A based at least in part on the one or more support seeker data objects. Additional details are described herein.

It is noted that various components of the example integrated service and asset computing platform 105 may leverage the same computer or computing apparatus to perform various operations. For example, one or more components of one or more network computing devices 107 (such as, but not limited to, network computing device 107A, network computing device 107B, network computing device 107C, network computing device 107D, network computing device 107E, network computing device 107F, and/or network computing device 107G) in the example integrated service and asset computing platform 105 may leverage the same computer or computing apparatus to perform various operations.

### Example Apparatuses for Implementing Embodiments of the Present Disclosure

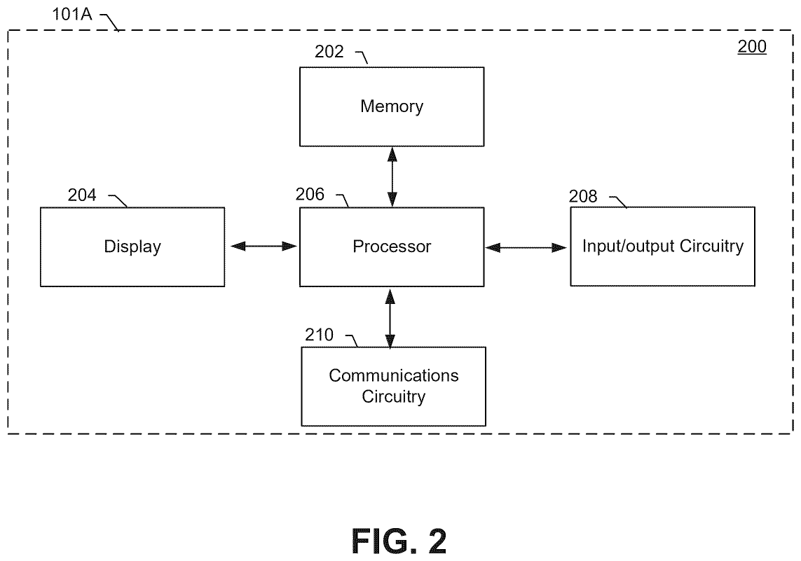

Referring now to FIG. 2, an example block diagram illustrates example components of an example apparatus in accordance with some embodiments of the present disclosure. For example, example user computing devices in various embodiments of the present disclosure (for example, the one or more support provider computing devices 101 and/or the one or more support seeker computing devices 103 in FIG. 1) may include one or more computing systems, such as the apparatus 200 shown in FIG. 2.

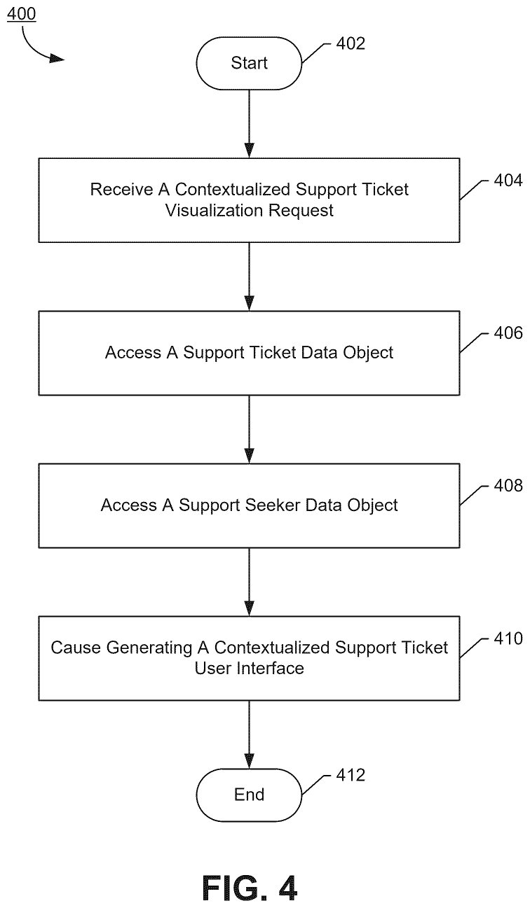

In some embodiments, the apparatus 200 may be configured to execute at least some of the operations described above with respect to FIG. 1 and below with respect to FIG. 4 to FIG. 10D. In some embodiments, the apparatus 200 may include a processor 206, a memory 202, an input/output circuitry 208, a communications circuitry 210, and/or a display 204.

Although the processor 206, the memory 202, the input/output circuitry 208, the communications circuitry 210, and the display 204 may be described with respect to their functions, it should be understood that the particular implementations necessarily include the use of particular hardware. It should also be understood that certain of the processor 206, the memory 202, the input/output circuitry 208, the communications circuitry 210, and/or the display 204 may include similar or common hardware. For example, two sets of circuitries may both leverage use of the same processor, network interface, storage medium, or the like to perform their associated functions, such that duplicate hardware is not required for each set of circuitries.

In some embodiments, the apparatus 200 may be configured to execute the operations described herein. Although the components are described with respect to functional limitations, it should be understood that the particular implementations necessarily include the use of particular hardware. It should also be understood that certain of the components described herein may include similar or common hardware. For example, two sets of circuitries may both leverage use of the same processor, network interface, storage medium, or the like to perform their associated functions, such that duplicate hardware is not required for each set of circuitries. The use of the term “circuitry” as used herein with respect to components of the apparatus should therefore be understood to include particular hardware configured to perform the functions associated with the particular circuitry as described herein.

In some embodiments, the processor 206 (and/or co-processor or any other processing circuitry assisting or otherwise associated with the processor) may be in communication with the memory 202 via a bus for passing information among components of the apparatus. In some embodiments, the memory 202 is non-transitory and may include, for example, one or more volatile and/or non-volatile memories. In some embodiments, for example, the memory 202 may be an electronic storage device (e.g., a computer readable storage medium). In some embodiments, the memory 202 may be configured to store information, data, content, applications, instructions, or the like, for enabling the apparatus 200 to carry out various functions in accordance with example embodiments of the present disclosure.

In some embodiments, the processor 206 may be embodied in a number of different ways and may, for example, include one or more processing devices configured to perform independently. Additionally, or alternatively, the processor 206 may include one or more processors configured in tandem via a bus to enable independent execution of instructions, pipelining, and/or multithreading. In some embodiments, the use of the term “processing circuitry” may be understood to include a single core processor, a multi-core processor, multiple processors internal to the apparatus, and/or remote or “cloud” processors.

In an example embodiment, the processor 206 may be configured to execute instructions stored in the memory 202 or otherwise accessible to the processor. Alternatively, or additionally, the processor 206 may be configured to execute hard-coded functionality. As such, whether configured by hardware or software methods, or by a combination thereof, the processor may represent an entity (e.g., physically embodied in circuitry) capable of performing operations according to an embodiment of the present disclosure while configured accordingly. Alternatively, as another example, when the processor 206 is embodied as an executor of software instructions, the instructions may specifically configure the processor to perform the algorithms and/or operations described herein when the instructions are executed.

In some embodiments, the apparatus 200 may include the input/output circuitry 208 that may, in turn, be in communication with the processor 206 to provide output to the user and, in some embodiments, to receive an indication of a user input. The input/output circuitry 208 may comprise a user interface circuitry and may include a display, which may comprise a web user interface, a mobile application, a user computing device, a kiosk, or the like. In some embodiments, the input/output circuitry 208 may also include a keyboard, a mouse, a joystick, a touch screen, touch areas, soft keys, a microphone, a speaker, or other input/output mechanisms. In some embodiments, the processor and/or user interface circuitry comprising the processor may be configured to control one or more functions of one or more user interface elements through computer program instructions (e.g., software and/or firmware) stored on a memory accessible to the processor (e.g., the memory 202, and/or the like).

In some embodiments, the apparatus 200 may include the display 204 that may, in turn, be in communication with the processor 206 to display renderings of various user interfaces. In various examples of the present disclosure, the display 204 may include a liquid crystal display (LCD), a light-emitting diode (LED) display, a plasma (PDP) display, a quantum dot (QLED) display, and/or the like.

In some embodiments, the communications circuitry 210 may be any means such as a device or circuitry embodied in either hardware or a combination of hardware and software that is configured to receive and/or transmit data from/to a network and/or any other device, circuitry, or module in communication with the apparatus 200. In this regard, the communications circuitry 210 may include, for example, a network interface for enabling communications with a wired or wireless communication network. For example, the communications circuitry 210 may include one or more network interface cards, antennae, buses, switches, routers, modems, and supporting hardware and/or software, or any other device suitable for enabling communications via a network. Additionally, or alternatively, the communication interface may include the circuitry for interacting with the antenna(s) to cause transmission of signals via the antenna(s) or to handle receipt of signals received via the antenna(s).

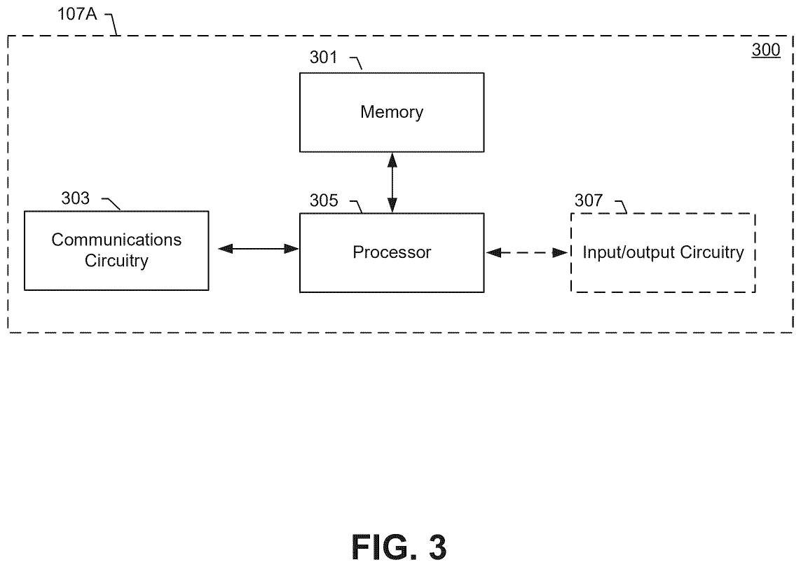

Referring now to FIG. 3, an example block diagram illustrates example components of an example apparatus in accordance with some embodiments of the present disclosure. For example, example network computing devices in various embodiments of the present disclosure (for example, the one or more network computing devices 107 in FIG. 1) may include one or more computing systems, such as the apparatus 300 shown in FIG. 3.

In some embodiments, the apparatus 300 may be configured to execute at least some of the operations described above with respect to FIG. 1 and below with respect to FIG. 4 to FIG. 10D. In some embodiments, the apparatus 300 may include a processor 305, a memory 301, an input/output circuitry 307, and a communications circuitry 303.

Although the processor 305, the memory 301, the input/output circuitry 307, and the communications circuitry 303 may be described with respect to their functions, it should be understood that the particular implementations necessarily include the use of particular hardware. It should also be understood that certain of the processor 305, the memory 301, the input/output circuitry 307, and/or the communications circuitry 303 may include similar or common hardware. For example, two sets of circuitries may both leverage use of the same processor, network interface, storage medium, or the like to perform their associated functions, such that duplicate hardware is not required for each set of circuitries.

In some embodiments, the processor 305 (and/or co-processor or any other processing circuitry assisting or otherwise associated with the processor) may be in communication with the memory 301 via a bus for passing information among components of the apparatus. In some embodiments, the memory 301 is non-transitory and may include, for example, one or more volatile and/or non-volatile memories. In some embodiments, for example, the memory 301 may be an electronic storage device (e.g., a computer-readable storage medium). In some embodiments, the memory 301 may be configured to store information, data, content, applications, instructions, or the like for enabling the apparatus to carry out various functions in accordance with example embodiments of the present disclosure.

In some embodiments, the processor 305 may be embodied in a number of different ways and may, for example, include one or more processing devices configured to perform independently. In some examples, the processor 305 may include one or more processors configured in tandem via a bus to enable independent execution of instructions, pipelining, and/or multithreading. The use of the term “processor” or “processing circuitry” may be understood to include a single core processor, a multi-core processor, multiple processors internal to the apparatus, and/or remote or “cloud” processors.

In some embodiments, the processor 305 may be configured to execute instructions stored in the memory 301 or otherwise accessible to the processor 305. In some examples, the processor 305 may be configured to execute hard-coded functionalities. In some embodiments, whether configured by hardware or software methods, or by a combination thereof, the processor 305 may represent an entity (e.g., physically embodied in circuitry) capable of performing operations according to an embodiment of the present disclosure while configured accordingly. In some embodiments, when the processor 305 is embodied as an executor of software instructions, the instructions may specifically configure the processor 305 to perform the algorithms and/or operations described herein when the instructions are executed.

In some embodiments, the apparatus 300 may optionally include the input/output circuitry 307 that may, in turn, be in communication with the processor 305 to provide output to the user and, in some embodiments, to receive an indication of a user input. In some embodiments, the input/output circuitry 307 may comprise a user interface circuitry and may include a display, which may comprise a web user interface, a mobile application, a user computing device, a kiosk, or the like. In some embodiments, the input/output circuitry 307 may include a keyboard, a mouse, a joystick, a touch screen, touch areas, soft keys, a microphone, a speaker, or other input/output mechanisms. In some embodiments, the processor and/or user interface circuitry comprising the processor may be configured to control one or more functions of one or more user interface elements through computer program instructions (e.g., software and/or firmware) stored on a memory accessible to the processor (e.g., the memory 301, and/or the like).

In some embodiments, the communications circuitry 303 may be any means such as a device or circuitry embodied in either hardware or a combination of hardware and software that is configured to receive and/or transmit data from/to a network and/or any other device, circuitry, or module in communication with the apparatus 300. In some embodiments, the communications circuitry 303 may include, for example, a network interface for enabling communications with a wired or wireless communication network (such as the communication network described above in connection with FIG. 1). In some embodiments, the communications circuitry 303 may include one or more network interface cards, antennae, buses, switches, routers, modems, and supporting hardware and/or software, or any other device suitable for enabling communications via a network. In some embodiments, the communications circuitry 303 may include the circuitry for interacting with the antenna/antennae to cause transmission of signals via the antenna/antennae or to handle receipt of signals received via the antenna/antennae.

It is also noted that all or some of the information discussed herein can be based on data that is received, generated and/or maintained by one or more components of apparatus 300. In some embodiments, one or more external systems (such as a remote cloud computing and/or data storage system) may also be leveraged to provide at least some of the functionality discussed herein.

In some embodiments, other elements of the apparatus 300 may provide or supplement the functionality of particular circuitry. For example, the processor 305 may provide processing functionality, the memory 301 may provide storage functionality, the communications circuitry 303 may provide network interface functionality, and the like. As will be appreciated, any such computer program instructions and/or other type of code may be loaded onto a computer, processor or other programmable apparatus's circuitry to produce a machine, such that the computer, processor or other programmable circuitry that execute the code on the machine creates the means for implementing various functions, including those described herein.

### Example Methods for Implementing Embodiments of the Present Disclosure

Various example methods described herein, including, for example, those as shown in FIG. 4 to FIG. 10D, may provide various technical advantages and/or improvements described above.

It is noted that each block of the flowchart, and combinations of blocks in the flowchart, may be implemented by various means such as hardware, firmware, circuitry and/or other devices associated with execution of software including one or more computer program instructions. For example, one or more of the methods described in FIG. 4 to FIG. 10D may be embodied by computer program instructions, which may be stored by a non-transitory memory of an apparatus employing an embodiment of the present disclosure and executed by a processor in the apparatus. These computer program instructions may direct a computer or other programmable apparatus to function in a particular manner, such that the instructions stored in the computer-readable storage memory produce an article of manufacture, the execution of which implements the function specified in the flowchart block(s).

As described above and as will be appreciated based on this disclosure, embodiments of the present disclosure may be configured as methods, mobile devices, backend network devices, and the like. Accordingly, embodiments may comprise various means including entirely of hardware or any combination of software and hardware. Furthermore, embodiments may take the form of a computer program product on at least one non-transitory computer-readable storage medium having computer-readable program instructions (e.g., computer software) embodied in the storage medium. Similarly, embodiments may take the form of a computer program code stored on at least one non-transitory computer-readable storage medium. Any suitable computer-readable storage medium may be utilized including non-transitory hard disks, CD-ROMs, flash memory, optical storage devices, or magnetic storage devices.

### Example Contextualized Support Ticket User Interfaces

Referring now to FIG. 4, an example flow diagram illustrating example methods associated with generating example contextualized support ticket user interfaces in accordance with some embodiments of the present disclosure is provided.

For example, example methods illustrated in FIG. 4 resolve technical issues associated with integrated service and asset computing platforms and improve the functioning of integrated service and asset computing platforms by generating contextualized support ticket user interfaces based on not only support ticket data objects, but also support seeker data objects that are stored within the example integrated service and asset computing platform. As such, example contextualized support ticket user interfaces in accordance with example methods illustrated in FIG. 4 provide rich contextual data associated with support seekers to support providers while such example methods improve speed of rendering such user interfaces and usability of integrated service and asset computing platforms.

In the example shown in FIG. 4, an example method 400 starts at step/operation 402 and then proceeds to step/operation 404. At step/operation 404, in some embodiments, a processing circuitry (such as, but not limited to, the processor 305 of the apparatus 300 described in connection with at least FIG. 1 and FIG. 3, and/or the processor 206 of the apparatus 200 described in connection with at least FIG. 1 and FIG. 2) receives a contextualized support ticket visualization request.

In some embodiments, the processing circuitry receives the contextualized support ticket visualization request from a support provider computing device. In some embodiments, the contextualized support ticket visualization request comprises support ticket identifying metadata.

For example, the contextualized support ticket visualization request may be generated by a support provider computing device (for example, the support provider computing device 101A in FIG. 1) that is associated with a support provider (for example, a customer support agent). As an example, a support seeker (for example, an employee of Acme Corporation) may encounter issues when installing a software product and may request support through an example integrated service and asset computing platform (for example, the integrated service and asset computing platform 105 in FIG. 1). In such an example, a support provider (for example, a customer support agent) may be assigned to manage, track, and/or resolve said issues, and may operate the support provider computing device 101A to generate the contextualized support ticket visualization request to request the example integrated service and asset computing platform 105 to generate a contextualized support ticket user interface on the support provider computing device 101A, which visualizes one or more support ticket data objects that describe information and content associated with said issues. Continuing in this example, the support provider computing device 101A may generate the contextualized support ticket visualization request and transmit the contextualized support ticket visualization request to the integrated service and asset computing platform 105.

Continuing in the example above, the contextualized support ticket visualization request may comprise support ticket identifying metadata that identifies one or more support ticket data objects that describe information and content associated with said issues and are stored in one or more data storage devices in the example integrated service and asset computing platform (for example, from one or more data storage devices 109 described above in connection with FIG. 1). In such an example, in response to receiving the contextualized support ticket visualization request, one or more network computing devices in the integrated service and asset computing platform (for example, the one or more network computing devices 107 in the example integrated service and asset computing platform 105 in FIG. 1) may parse the support ticket identifying metadata from the contextualized support ticket visualization request.

Referring back to FIG. 4, subsequent and/or in response to step/operation 404, the example method 400 proceeds to step/operation 406. At step/operation 406, in some embodiments, a processing circuitry (such as, but not limited to, the processor 305 of the apparatus 300 described in connection with at least FIG. 1 and FIG. 3, and/or the processor 206 of the apparatus 200 described in connection with at least FIG. 1 and FIG. 2) accesses a support ticket data object.

In some embodiments, the processing circuitry accesses the support ticket data object from an example integrated service and asset computing platform based at least in part on the support ticket identifying metadata that is from the contextualized support ticket visualization request received at step/operation 404. In some embodiments, the support ticket data object may comprise support seeker identifying metadata and/or support ticket content metadata.

Continuing in the example above, one or more network computing devices in the integrated service and asset computing platform (for example, the one or more network computing devices 107 in the example integrated service and asset computing platform 105 described above in connection with FIG. 1) may traverse support ticket data objects stored in the one or more data storage devices of the integrated service and asset computing platform (for example, in the one or more data storage devices 109 in the example integrated service and asset computing platform 105 described above in connection with FIG. 1) based on the support ticket identifying metadata that is associated with the contextualized support ticket visualization request received at step/operation 404. Through traversing, the one or more network computing devices 107 in the integrated service and asset computing platform 105 may identify one or more support ticket data objects that comprise metadata matching the support ticket identifying metadata. In such an example, the identified one or more support ticket data objects comprise data, information and content associated with issues associated with installing the software product by the employee of Acme Corporation.

Continuing in the example above, the support ticket data object accessed by the processing circuitry may comprise support seeker identifying metadata that uniquely identifies one or more support seekers associated with the one or more support ticket data objects. For example, the identified one or more support ticket data objects may comprise support seeker identifying metadata identifying the Acme Corporation and/or the employee of Acme Corporation. In such an example, the support seeker identifying metadata indicates that the Acme Corporation and/or the employee of Acme Corporation is the support seeker who requests support on issues associated with installing the software product. Continuing in this example, the one or more network computing devices 107 in the example integrated service and asset computing platform 105 may parse the support seeker identifying metadata from the support ticket data object accessed at step/operation 406.

Continuing in the example above, the support ticket data object accessed by the processing circuitry may comprise support ticket content metadata that contains details associated with the issues associated with installing the software product. Continuing in this example, the one or more network computing devices 107 in the example integrated service and asset computing platform 105 may parse the support ticket content metadata from the support ticket data object accessed at step/operation 406.

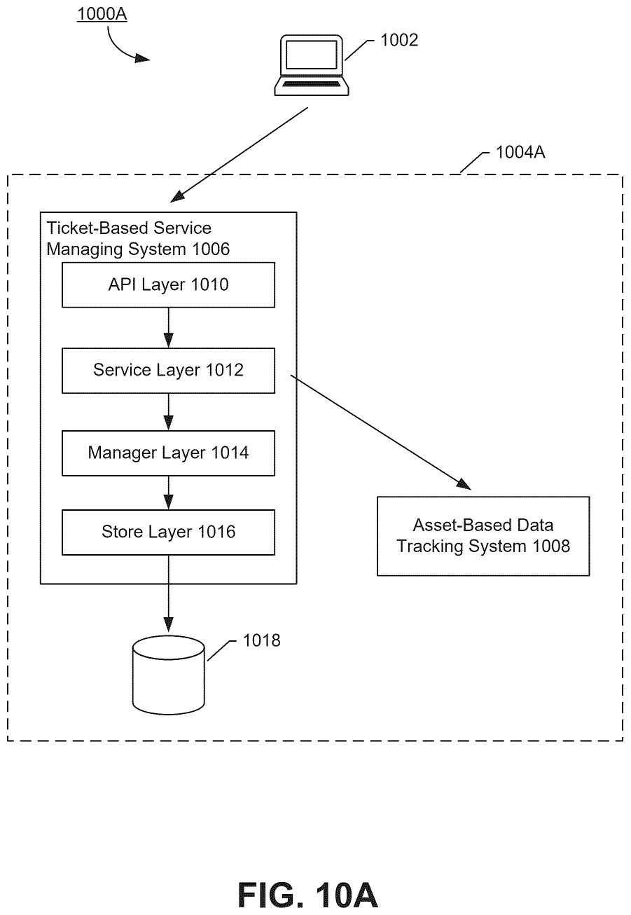

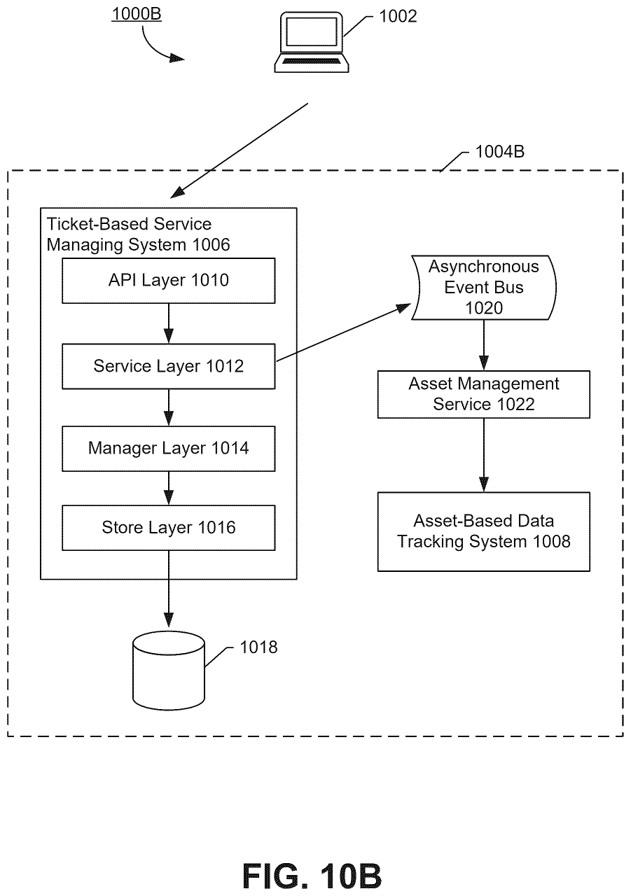

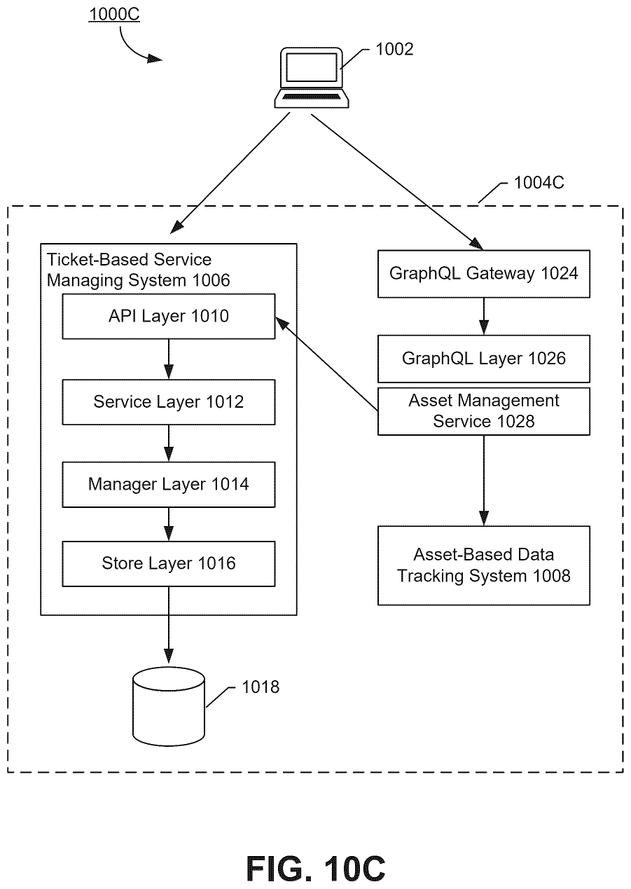

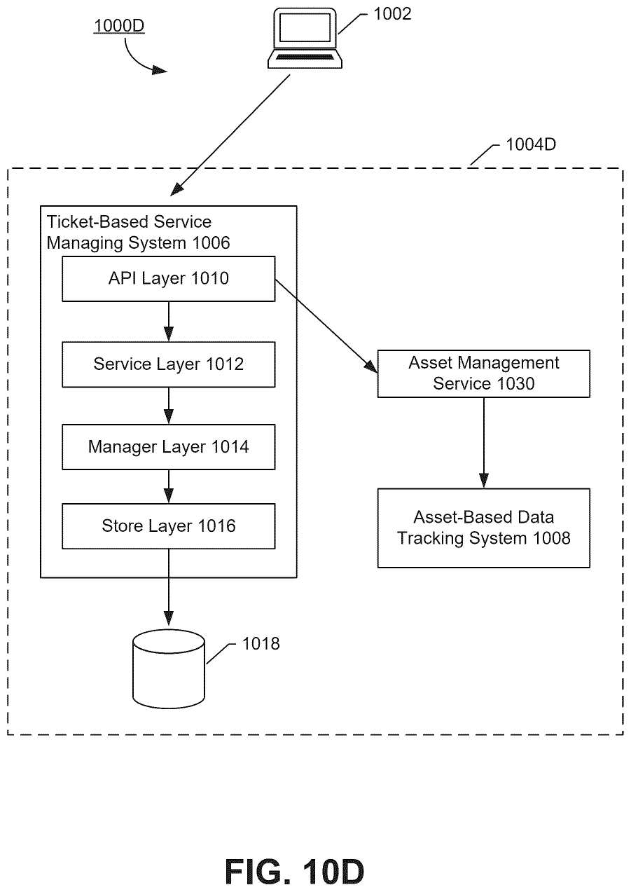

In some embodiments, the support ticket data object is stored in a ticket-based service managing system of the example integrated service and asset computing platform. In such embodiments, the processing circuitry accesses the support ticket data object from the ticket-based service managing system. Additional details associated with the ticket-based service managing system are described herein, including, but not limited to, in connection with at least FIG. 10A to FIG. 10D.

Referring back to FIG. 4, subsequent and/or in response to step/operation 406, the example method 400 proceeds to step/operation 408. At step/operation 408, in some embodiments, a processing circuitry (such as, but not limited to, the processor 305 of the apparatus 300 described in connection with at least FIG. 1 and FIG. 3, and/or the processor 206 of the apparatus 200 described in connection with at least FIG. 1 and FIG. 2) accesses a support seeker data object.

In some embodiments, the processing circuitry accesses a support seeker data object from an integrated service and asset computing platform based at least in part on the support seeker identifying metadata associated with the support ticket data object accessed at step/operation 406. As described above, the support seeker data object may comprise support seeker context metadata, and the support seeker context metadata may comprise customer context metadata, product and service context metadata, asset context metadata, work item context metadata, organization context metadata, and/or contract and entitlement context metadata.

Continuing in the example above, one or more network computing devices in the integrated service and asset computing platform (for example, the one or more network computing devices 107 in the example integrated service and asset computing platform 105 described above in connection with FIG. 1) may traverse support seeker data objects stored in the one or more data storage devices of the integrated service and asset computing platform (for example, in the one or more data storage devices 109 in the example integrated service and asset computing platform 105 described above in connection with FIG. 1) based on the support seeker identifying metadata that is associated with the support ticket data object accessed at step/operation 406. Through traversing, the one or more network computing devices 107 in the integrated service and asset computing platform 105 may identify one or more support seeker data objects that comprise metadata matching the support seeker identifying metadata. In such an example, the identified one or more support seeker data objects comprise data, information and content associated with Acme Corporation and/or the employee from Acme Corporation.

Continuing from the example above, the identified one or more support seeker data objects may comprise support seeker context metadata associated with Acme Corporation and/or the employee from Acme Corporation. For example, the support seeker context metadata may comprise customer context metadata, product and service context metadata, asset context metadata, work item context metadata, organization context metadata, and contract and/or entitlement context metadata. In such an example, the customer context metadata may describe personal information related to the employee of Acme Corporation. The product and service context metadata may describe information related to product and services associated with Acme Corporation and/or the employee from the Acme Corporation. The asset context metadata may describe information related to assets associated with Acme Corporation and/or the employee from Acme Corporation. The work item context metadata may describe information related to work items associated with Acme Corporation and/or the employee from Acme Corporation. The organization context metadata may describe organization information related to Acme Corporation. The contract and entitlement context metadata may describe information related to contract and entitlement associated with Acme Corporation and/or the employee from Acme Corporation.

While the description above provides example support seeker context metadata, it is noted that the scope of the present disclosure is not limited to the description above. In some embodiments, example support seeker context metadata may comprise additional or alternative context related data associated with Acme Corporation and/or the employee of Acme Corporation.

Continuing from the above example, the one or more network computing devices 107 in the example integrated service and asset computing platform 105 may parse the support seeker context metadata from the support seeker data object accessed at step/operation 408.

In some embodiments, the support seeker data object is stored in an asset-based data tracking system that is internal to the example integrated service and asset computing platform. In such embodiments, the processing circuitry accesses the support seeker data object from the asset-based data tracking system, thereby improving speed in rendering user interfaces. Additional details associated with the asset-based data tracking system are described herein, including, but not limited to, in connection with at least FIG. 10A to FIG. 10D.

Referring back to FIG. 4, subsequent and/or in response to step/operation 408, the example method 400 proceeds to step/operation 410. At step/operation 410, in some embodiments, a processing circuitry (such as, but not limited to, the processor 305 of the apparatus 300 described in connection with at least FIG. 1 and FIG. 3, and/or the processor 206 of the apparatus 200 described in connection with at least FIG. 1 and FIG. 2) causes generating a contextualized support ticket user interface.

In some embodiments, the processing circuitry causes generating the contextualized support ticket user interface on the support provider computing device based at least in part on the support ticket data object accessed at step/operation 406 and the support seeker data object accessed at step/operation 408. In some embodiments, the contextualized support ticket user interface comprises user interface components such as, but not limited to, a support seeker context user interface component and a support ticket description user interface component.

Continuing from the example above, one or more network computing devices in the integrated service and asset computing platform (for example, the one or more network computing devices 107 in the example integrated service and asset computing platform 105 described above in connection with FIG. 1) may cause the support provider computing device 101A to generate a support seeker context user interface component based at least in part on the support seeker context metadata from the support seeker data object accessed at step/operation 408.

For example, the one or more network computing devices 107 may generate data associated with the support seeker context user interface component based at least in part on the support seeker data object accessed at step/operation 408, and transmit such data to the support provider computing device 101A to cause the support provider computing device 101A to render the support seeker context user interface component on the user interface. In such an example, the support seeker context user interface component may display data and information associated with context of Acme Corporation and/or the employee of Acme Corporation, such as, but not limited to, customer context information, product and service context information, asset context information, work item context information, organization context information, contract and entitlement context information, and/or the like.

Similarly, the one or more network computing devices 107 may generate data associated with the support ticket description user interface component based at least in part on the support ticket data object accessed at step/operation 406, and transmit such data to the support provider computing device 101A to cause the support provider computing device 101A to render the support ticket description user interface component on the user interface. In such an example, the support ticket description user interface component may display data and information associated with the issues of installing the software product by the employee of Acme Corporation.

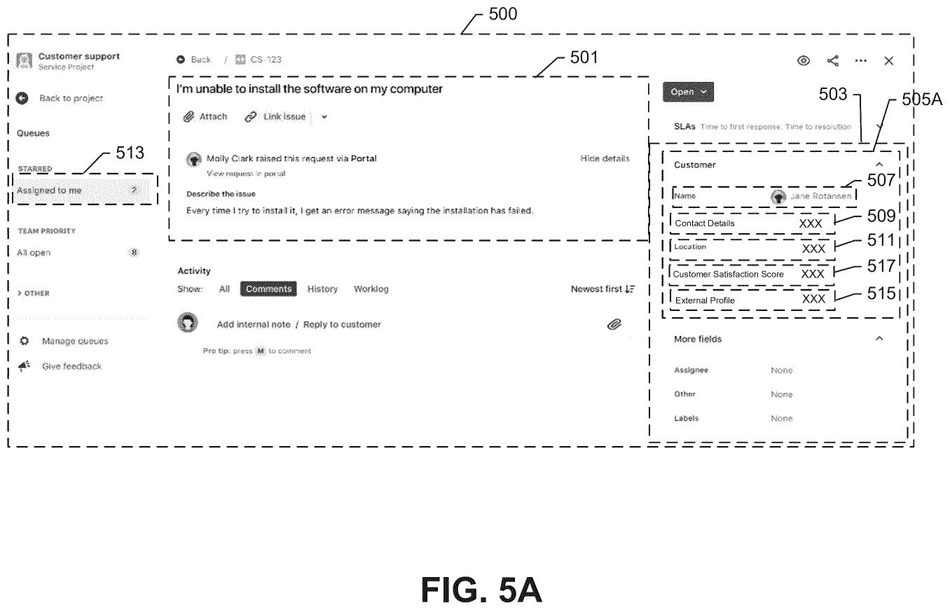

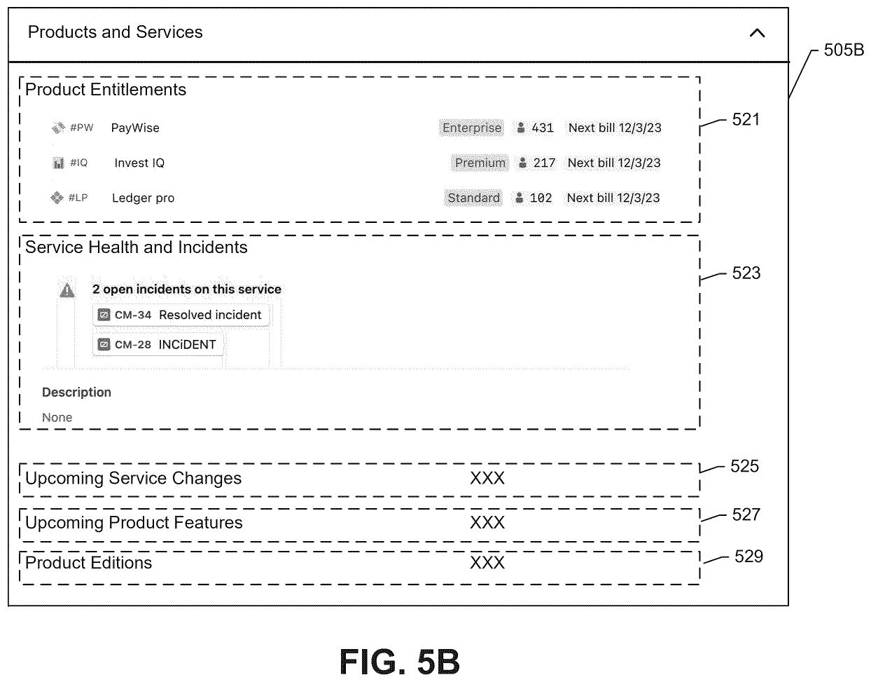

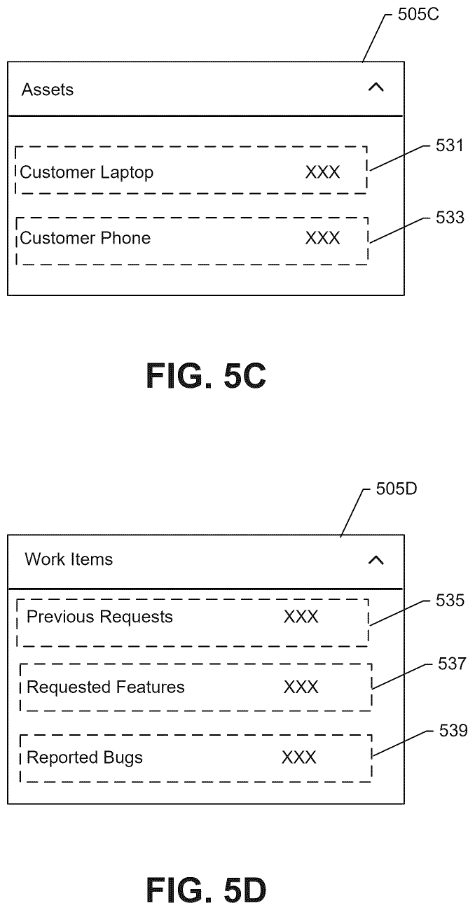

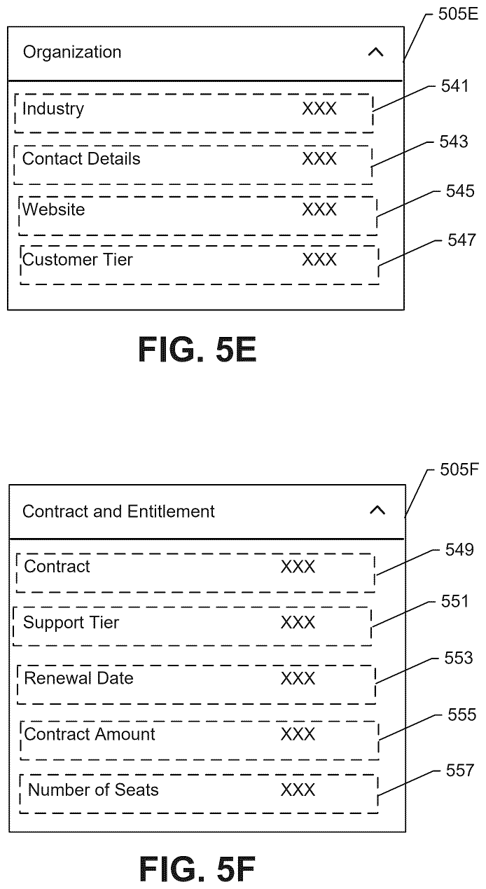

While the description above provides example data and information in the example support ticket description user interface component and the example support seeker context user interface component, it is noted that the scope of the present disclosure is not limited to the description above. In some examples, an example contextualized support ticket user interface may display additional and/or alternative data, information and/or user interface components. Additional details and examples associated with example contextualized support ticket user interfaces are described herein, including, but not limited to, those described in connection with at least FIG. 5A to FIG. 5F.

Referring back to FIG. 4, subsequent and/or in response to step/operation 410, the example method 400 proceeds to step/operation 412 and ends.

Referring now to FIG. 5A, an example visualization view illustrates an example contextualized support ticket user interface 500 in accordance with some embodiments of the present disclosure.

Similar to those described above, the example contextualized support ticket user interface 500 may be generated in response to a contextualized support ticket visualization request from a support provider computing device. For example, when a support provider clicks, tabs, or otherwise selects a contextualized support ticket visualization request user interface element 513 that is rendered on the support provider computing device, the support provider computing device generates and transmits a contextualized support ticket visualization request to an example integrated service and asset computing platform described herein. In some embodiments, the example integrated service and asset computing platform causes generating the contextualized support ticket user interface 500 based at least in part on accessing support ticket data object and support seeker data object, similar to various examples described herein.

In the example shown in FIG. 5A, the contextualized support ticket user interface 500 comprises a support ticket description user interface component 501 and a support seeker context user interface component 503.

In some embodiments, the support ticket description user interface component 501 may be displayed on a predominant portion of the contextualized support ticket user interface 500. In some embodiments, the support ticket description user interface component 501 may be generated based on support ticket content metadata of the support ticket data object that is accessed based on the support ticket identifying metadata from the contextualized support ticket visualization request, similar to various examples described herein. For example, the support ticket description user interface component 501 may be in the form of a user interface panel that displays the information technology issues that require support from the support provider based on the metadata from the support ticket data object.

In some embodiments, the support seeker context user interface component 503 is displayed adjacent to the support ticket description user interface component 501, and may be in a non-predominant portion of the contextualized support ticket user interface 500. In some embodiments, the support seeker context user interface component 503 may be generated based on support seeker context metadata associated with the support seeker data object. In some embodiments, the support seeker context user interface component may be in the form of a user interface panel that comprises one or more user interface elements displaying various support seeker context metadata associated with the support seeker.

For example, the support seeker context user interface component 503 may comprise one or more support seeker context metadata user interface elements for displaying various aspects of support seeker context metadata associated with the support seeker. For example, each of the support seeker context metadata user interface elements may be in the form of a collapsible user interface card within the support seeker context user interface component 503, thereby providing technical benefit of display or hiding various aspects of support seeker context metadata associated with the support seeker.

In the example shown in FIG. 5A, the support seeker context user interface component 503 comprises a customer context metadata user interface element 505A. In some embodiments, the customer context metadata user interface element 505A is generated based at least in part on the customer context metadata associated with the support seeker data object.

In the example shown in FIG. 5A, the customer context metadata user interface element 505A comprises a customer name metadata portion 507, a contact details metadata portion 509, a location metadata portion 511, a customer satisfaction score metadata portion 517, and an external profile metadata portion 515.

In some embodiments, the customer name metadata portion 507 may display a name of the customer who reported the information technology related issue described in the support ticket description user interface component 501. In some embodiments, the contact details metadata portion 509 may display contact information (for example, an email address, a telephone number, and/or the like) associated with the customer who reported the information technology related issue described in the support ticket description user interface component 501. In some embodiments, the location metadata portion 511 may display location information (for example, a work location, a home location, and/or the like) associated with the customer who reported the information technology related issue described in the support ticket description user interface component 501. In some embodiments, the customer satisfaction score metadata portion 517 may display a score that indicates a satisfaction level on information technology related support that is received by the customer who reported the information technology related issue described in the support ticket description user interface component 501. In some embodiments, the external profile metadata portion 515 may display one or more links to external profiles (for example, social network websites such as Linkedin®) associated with the customer who reported the information technology related issue described in the support ticket description user interface component 501.

As described above, the example contextualized support ticket user interface 500 provides rich contextual data (such as, but not limited to, customer name, contact details, location, customer satisfaction score, and external profile) associated with support seekers to support providers, thereby improving speed and usability of integrated service and asset computing platforms.

While FIG. 5A illustrates an example contextualized support ticket user interface in accordance with some embodiments of the present disclosure, it is noted that the scope of the present disclosure is not limited to the description above. In some embodiments, an example contextualized support ticket user interface may comprise one or more additional and/or alternative user interface elements. For example, an example contextualized support ticket user interface in accordance with some embodiments of the present disclosure may comprise a support seeker context user interface component that may additionally or alternatively comprise one or more other user interface elements, such as, but not limited to, product and service context metadata user interface elements, asset context metadata user interface elements, work item context metadata user interface elements, organization context metadata user interface elements, and/or contract and entitlement context metadata user interface elements, details of which are described and illustrated in connection with at least FIG. 5B to FIG. 5F.

Referring now to FIG. 5B, an example product and service context metadata user interface element 505B in accordance with some embodiments of the present disclosure is illustrated. In some embodiments, the example product and service context metadata user interface element 505B may be included as one of support seeker context metadata user interface elements in a support seeker context user interface component of an example contextualized support ticket user interface. In some embodiments, the product and service context metadata user interface element 505B is generated based at least in part on the product and service context metadata associated with the support seeker data object.

In some embodiments, the example product and service context metadata user interface element 505B comprises a product entitlement metadata portion 521, a service health and incidents metadata portion 523, an upcoming service changes metadata portion 525, an upcoming product features metadata portion 527, and a product editions metadata portion 529.

In some embodiments, the product entitlement metadata portion 521 may display product entitlement information associated with the support seeker. For example, the product and service context metadata may comprise data that identifies one or more software products to which the support seeker has purchased a license or has subscribed. In such an example, the product entitlement metadata portion 521 may display the name of such software products, renewal information associated with such software products, and/or the like.

In some embodiments, the service health and incidents metadata portion 523 may display health status information and/or incident information associated with services (for example, software-based functions as described above) that the support seeker uses. For example, the product and service context metadata may comprise service identifying metadata associated with the services that the support seeker uses. In such an example, a computing device may access service data objects based on the service identifying metadata, and render the service health and incidents metadata portion 523 based at least in part on the service data objects. For example, the service data objects may comprise data indicating a health status of the service (for example, whether the service is functional), any incident on the service (for example, whether there is a service outage), and/or the like. Displaying the service health and incidents metadata portion 523 may provide various technical benefits and advantages. For example, different software products may rely on the same service (for example, the same user authentication function), and displaying information associated with health and incident statuses of services may facilitate the support provider in addressing the information technology related issue reported by the support seeker.

In some embodiments, the upcoming service changes metadata portion 525 may display information associated with upcoming changes in services (for example, software-based functions as described above) that the support seeker uses. For example, the product and service context metadata may comprise service identifying metadata associated with the services that the support seeker uses. In such an example, a computing device may access service data objects based on the service identifying metadata, and render the upcoming service changes metadata portion 525 based at least in part on the service data objects. For example, the service data objects may comprise data indicating any changes to the service.

In some embodiments, the upcoming product features metadata portion 527 may display information associated with upcoming product features of the software product that the support seeker uses. For example, the product and service context metadata may comprise identifying metadata that identifies one or more software products to which the support seeker has purchased a license. In such an example, a computing device may identify one or more data objects that describe upcoming features associated with these software products based on the identifying metadata, and may generate the upcoming product features metadata portion 527 based on these data objects.

In some embodiments, the product editions metadata portion 529 may display information associated with editions of software products that the support seeker uses. For example, the product and service context metadata may comprise metadata that describe editions of software products that the support seeker uses.

While FIG. 5B illustrates an example product and service context metadata user interface element in accordance with some embodiments of the present disclosure, it is noted that the scope of the present disclosure is not limited to the description above. In some embodiments, an example product and service context metadata user interface element may comprise one or more additional and/or alternative metadata portions.

As described above, the example product and service context metadata user interface element 505B provides rich contextual data (such as, but not limited to, product entitlement information, service health and incidents information, service health and incidents information, upcoming product features information, and product editions information) associated with support seekers to support providers, thereby improving speed and usability of integrated service and asset computing platforms.

Referring now to FIG. 5C, an example asset context metadata user interface element 505C in accordance with some embodiments of the present disclosure is illustrated. In some embodiments, the example asset context metadata user interface element 505C may be included as one of support seeker context metadata user interface elements in a support seeker context user interface component of an example contextualized support ticket user interface.

In some embodiments, the asset context metadata user interface element 505C is generated based at least in part on the asset context metadata associated with the support seeker data object. For example, the asset context metadata may comprise asset identifying metadata that identifies one or more asset data objects that correspond to laptops owned by the support seeker. In such an example, a computing device may identify the one or more asset data objects based on the asset identifying metadata, and generate the asset context metadata user interface element 505C based on the one or more asset data objects.

In some embodiments, the example asset context metadata user interface element 505C comprises a customer laptop metadata portion 531 and a customer phone metadata portion 533. In some embodiments, the customer laptop metadata portion 531 may display information associated with laptops that the support seeker uses (such as, but not limited to, the model of the laptop, the processor details of the laptop, the operating system of the laptop, and/or the like). In some embodiments, the customer phone metadata portion 533 may display information associated with the phones that the support seeker uses (such as, but not limited to, the model of the phone, the operating system of the phone, and/or the like).

While FIG. 5C illustrates an example asset context metadata user interface element in accordance with some embodiments of the present disclosure, it is noted that the scope of the present disclosure is not limited to the description above. In some embodiments, an example asset context metadata user interface element may comprise one or more additional and/or alternative metadata portions.

As described above, the example asset context metadata user interface element 505C provides rich contextual data (such as, but not limited to, customer laptop information and customer phone information) associated with support seekers to support providers, thereby improving speed and usability of integrated service and asset computing platforms.

Referring now to FIG. 5D, an example work item context metadata user interface element 505D in accordance with some embodiments of the present disclosure is illustrated. In some embodiments, the example work item context metadata user interface element 505D may be included as one of support seeker context metadata user interface elements in a support seeker context user interface component of an example contextualized support ticket user interface. In some embodiments, the work item context metadata user interface element 505D is generated based at least in part on the work item context metadata associated with the support seeker data object.

In some embodiments, the example work item context metadata user interface element 505D comprises a previous request metadata portion 535, a requested features metadata portion 537, and a reported bugs metadata portion 539.

In some embodiments, the previous request metadata portion 535 may display information associated with any other information technology related issues that are previously reported by the support seeker. For example, the work item context metadata may comprise support ticket identifying metadata that identifies one or more support ticket data objects describing previous information technology related issues that are reported by the support seeker. In such an example, a computing device may access these support ticket data objects and generate the previous request metadata portion 535 based on these support ticket data objects.

In some embodiments, the requested features metadata portion 537 may display information associated with features requested by the support seeker. For example, the support seeker may submit requests for new features associated with software products and/or services that the support seeker uses, and the work item context metadata may store data and information associated with these new features that are requested by the support seeker.

In some embodiments, the reported bugs metadata portion 539 may display information associated with software bugs that are reported by the support seeker. For example, the support seeker may report bugs associated with software products and/or services that the support seeker uses, and the work item context metadata may store data and information associated with these bugs that are reported by the support seeker.

While FIG. 5D illustrates an example work item context metadata user interface element in accordance with some embodiments of the present disclosure, it is noted that the scope of the present disclosure is not limited to the description above. In some embodiments, an example work item context metadata user interface element may comprise one or more additional and/or alternative metadata portions.

As described above, the example work item context metadata user interface element 505D provides rich contextual data (such as, but not limited to, previous request information, requested features information, and reported bugs information) associated with support seekers to support providers, thereby improving speed and usability of integrated service and asset computing platforms.

Referring now to FIG. 5E, an example organization context metadata user interface element 505E in accordance with some embodiments of the present disclosure is illustrated. In some embodiments, the example organization context metadata user interface element 505E may be included as one of support seeker context metadata user interface elements in a support seeker context user interface component of an example contextualized support ticket user interface. In some embodiments, the organization context metadata user interface element 505E is generated based at least in part on the organization context metadata associated with the support seeker data object. For example, the organization context metadata may include name(s) and other details associated with organizations that employ the support seeker, represented by the support seeker, and/or otherwise associated with the support seeker.

In some embodiments, the example organization context metadata user interface element 505E comprises an industry metadata portion 541, a contact details metadata portion 543, a website metadata portion 545, and a customer tier metadata portion 547.

In some embodiments, the industry metadata portion 541 may display information associated with the industry associated with the organization. In some embodiments, the contact details metadata portion 543 may display contact information associated with the organization. In some embodiments, the website metadata portion 545 may display the website link and/or domain information associated with the organization. In some embodiments, the customer tier metadata portion 547 may display a customer tier that is assigned to the organization by the support provider (which may specify information such as, but not limited to, an expected turnaround time for resolving information technology related issues reported by support seekers from the organization).

While FIG. 5E illustrates an example organization context metadata user interface element in accordance with some embodiments of the present disclosure, it is noted that the scope of the present disclosure is not limited to the description above. In some embodiments, an example organization context metadata user interface element may comprise one or more additional and/or alternative metadata portions.

As described above, the example organization context metadata user interface element 505E provides rich contextual data (such as, but not limited to, industry information, contact details information, website information, and customer tier information) associated with support seekers to support providers, thereby improving speed and usability of integrated service and asset computing platforms.

Referring now to FIG. 5F, an example contract and entitlement context metadata user interface element 505F in accordance with some embodiments of the present disclosure is illustrated. In some embodiments, the example contract and entitlement context metadata user interface element 505F may be included as one of support seeker context metadata user interface elements in a support seeker context user interface component of an example contextualized support ticket user interface. In some embodiments, the contract and entitlement context metadata user interface element 505F is generated based at least in part on the contract and entitlement context metadata associated with the support seeker data object.

In some embodiments, the example contract and entitlement context metadata user interface element 505F comprises a contract metadata portion 549, a support tier metadata portion 551, a renewal date metadata portion 553, a contract amount metadata portion 555, and a number of seats metadata portion 557.

In some embodiments, the contract metadata portion 549 may display information associated with contracts and/or agreements (such as, but not limited to, service agreements) that are executed between the support seeker and the support provider. In some embodiments, the support tier metadata portion 551 may display information associated with a support tier (for example, a level associated with information technology related support such as, but not limited to, the level of technical expertise of the support provider) for the support seeker as specified in the contracts and/or agreements. In some embodiments, the renewal date metadata portion 553 may display information associated with the date on which the contracts and/or agreements are to be renewed. In some embodiments, the contract amount metadata portion 555 may display associated with an amount of fees that the support seeker pays for receiving information technology related services from the support provider as specified in the contracts and/or agreements. In some embodiments, the number of seats metadata portion 557 may display information such as the number of users that are eligible to receive information technology related support from the support provider as specified in the contracts and/or agreements.

While FIG. 5F illustrates an example contract and entitlement context metadata user interface element in accordance with some embodiments of the present disclosure, it is noted that the scope of the present disclosure is not limited to the description above. In some embodiments, an example contract and entitlement context metadata user interface element may comprise one or more additional and/or alternative metadata portions.

As described above, the contract and entitlement context metadata user interface element 505F provides rich contextual data (such as, but not limited to, contract information, support tier information, renewal date information, contract amount information and number of seats information) associated with support seekers to support providers, thereby improving speed and usability of integrated service and asset computing platforms.

### Example Allocated Support Seeker Organization User Interfaces

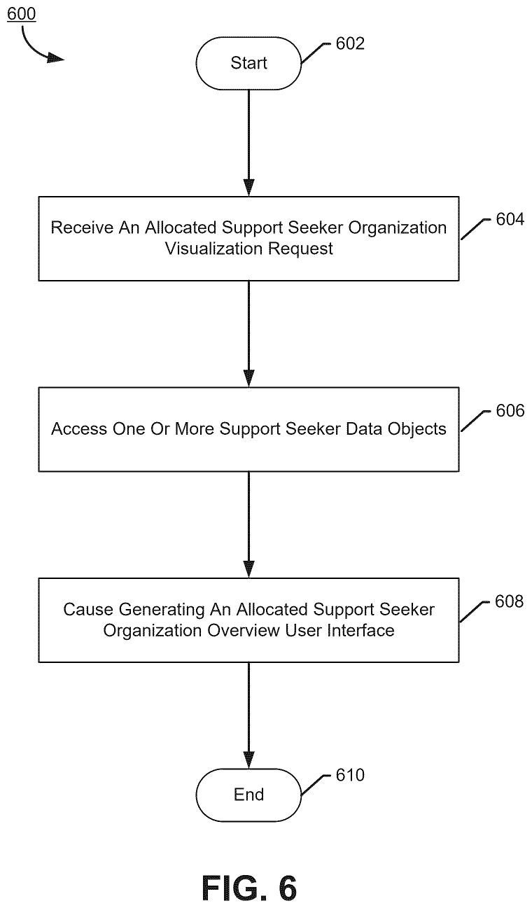

Referring now to FIG. 6, an example flow diagram illustrating example methods associated with generating example allocated support seeker organization overview user interfaces in accordance with some embodiments of the present disclosure is provided.

For example, example methods illustrated in FIG. 6 resolve technical issues associated with integrated service and asset computing platforms and improve the functioning of the integrated service and asset computing platform by generating allocated support seeker organization overview user interfaces based on support seeker data objects that are stored within the example integrated service and asset computing platform. As such, example allocated support seeker organization overview user interfaces in accordance with example methods illustrated in FIG. 6 provide rich contextual data associated with support seekers to support providers while such example methods improve speed of rendering such user interfaces and usability of integrated service and asset computing platforms.

In the example shown in FIG. 6, an example method 600 starts at step/operation 602 and then proceeds to step/operation 604. At step/operation 604, in some embodiments, a processing circuitry (such as, but not limited to, the processor 305 of the apparatus 300 described in connection with at least FIG. 1 and FIG. 3, and/or the processor 206 of the apparatus 200 described in connection with at least FIG. 1 and FIG. 2) receives an allocated support seeker organization visualization request.

In some embodiments, the processing circuitry receives the allocated support seeker organization visualization request from a support provider computing device. In some embodiments, the allocated support seeker organization visualization request comprises support provider identifying metadata.

For example, the allocated support seeker organization visualization request may be generated by a support provider computing device (for example, the support provider computing device 101A in FIG. 1) that is associated with a support provider who is a customer support agent. As an example, the customer support agent may be assigned or allocated to manage, track, and/or resolve information technology related issues from various support seekers that are associated with various organizations. In such an example, the customer support agent may operate the support provider computing device 101A to generate the allocated support seeker organization visualization request to request the example integrated service and asset computing platform 105 to generate an allocated support seeker organization overview user interface on the support provider computing device 101A, which visualizes information and content associated with organizations that the customer support agent have been allocated to. Continuing in this example, the support provider computing device 101A may generate the allocated support seeker organization visualization request and transmit the allocated support seeker organization visualization request to the integrated service and asset computing platform 105.

Continuing in the example above, the allocated support seeker organization visualization request may comprise support provider identifying metadata that uniquely identifies the customer support agent. In such an example, in response to receiving the allocated support seeker organization visualization request, one or more network computing devices in the integrated service and asset computing platform (for example, the one or more network computing devices 107 in the example integrated service and asset computing platform 105 in FIG. 1) may parse the support provider identifying metadata from the allocated support seeker organization visualization request.

Referring back to FIG. 6, subsequent and/or in response to step/operation 604, the example method 600 proceeds to step/operation 606. At step/operation 606, in some embodiments, a processing circuitry (such as, but not limited to, the processor 305 of the apparatus 300 described in connection with at least FIG. 1 and FIG. 3, and/or the processor 206 of the apparatus 200 described in connection with at least FIG. 1 and FIG. 2) accesses one or more support seeker data objects.

As described above, in some embodiments, an example support seeker data object may comprise support provider identifying metadata that identifies one or more support providers who provide information technology related support to the support seeker associated with the example support seeker data object. In some embodiments, the processing circuitry accesses one or more support seeker data objects from an example integrated service and asset computing platform based at least in part on the support provider identifying metadata in the allocated support seeker organization visualization request received at step/operation 604.

Continuing in the example above, one or more network computing devices in the integrated service and asset computing platform (for example, the one or more network computing devices 107 in the example integrated service and asset computing platform 105 described above in connection with FIG. 1) may traverse support seeker data objects stored in the one or more data storage devices of the integrated service and asset computing platform (for example, in the one or more data storage devices 109 in the example integrated service and asset computing platform 105 described above in connection with FIG. 1) based on the support provider identifying metadata that is associated with the allocated support seeker organization visualization request received at step/operation 604. Through traversing, the one or more network computing devices 107 in the integrated service and asset computing platform 105 may identify one or more support seeker data objects that comprise metadata matching the support provider identifying metadata. In such an example, the identified one or more support seeker data objects comprise data, information and content associated with support seekers that are allocated to the customer support agent.

In some embodiments, the support seeker data object is stored in an asset-based data tracking system of the example integrated service and asset computing platform. In such embodiments, the processing circuitry accesses the support seeker data object from the asset-based data tracking system. Additional details associated with the asset-based data tracking system are described herein, including, but not limited to, in connection with at least FIG. 10A to FIG. 10D.

Referring back to FIG. 6, subsequent and/or in response to step/operation 606, the example method 600 proceeds to step/operation 608. At step/operation 608, in some embodiments, a processing circuitry (such as, but not limited to, the processor 305 of the apparatus 300 described in connection with at least FIG. 1 and FIG. 3, and/or the processor 206 of the apparatus 200 described in connection with at least FIG. 1 and FIG. 2) causes generating an allocated support seeker organization overview user interface.

In some embodiments, the processing circuitry causes generating an allocated support seeker organization overview user interface on the support provider computing device based at least in part on the one or more support seeker data objects accessed at step/operation 606.

Continuing from the example above, one or more network computing devices in the integrated service and asset computing platform (for example, the one or more network computing devices 107 in the example integrated service and asset computing platform 105 described above in connection with FIG. 1) may cause the support provider computing device 101A to generate an allocated support seeker organization overview user interface that comprises an allocated organization tabular user interface element. For example, the allocated organization tabular user interface element may comprise a table rendering that comprises an allocated organization name metadata portion (which displays names of organizations that are allocated to the customer support agent to provide information technology related support to) and an allocated organization domain metadata portion (which displays domains of organizations that are allocated to the customer support agent to provide information technology related support to).

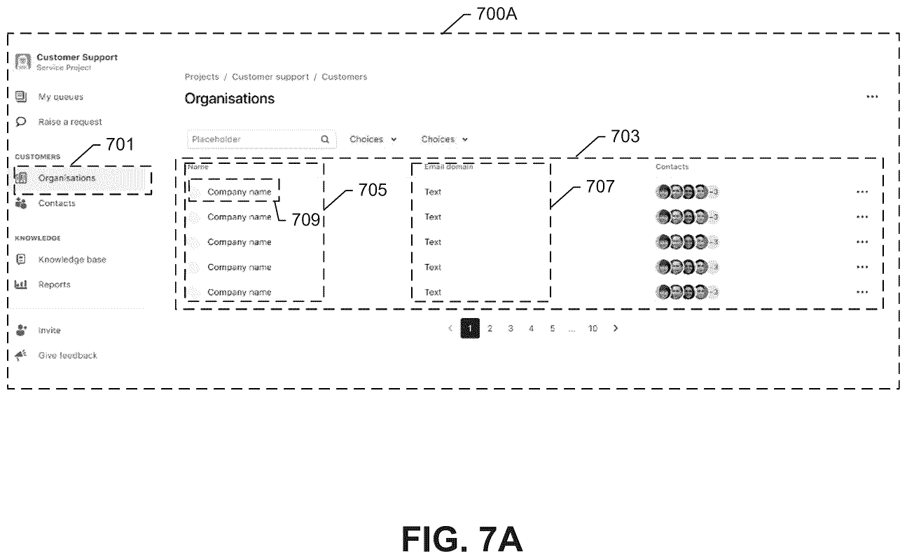

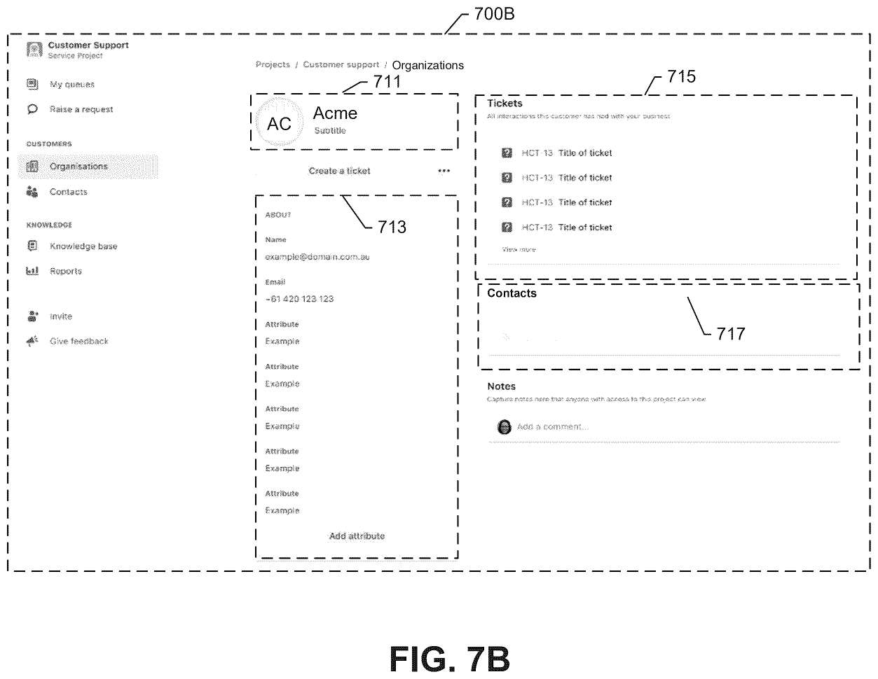

Additional details and examples associated with example allocated organization tabular user interfaces are described herein, including, but not limited to, those described in connection with at least FIG. 7A and FIG. 7B.

Referring back to FIG. 6, subsequent and/or in response to step/operation 608, the example method 600 proceeds to step/operation 610 and ends.

Referring now to FIG. 7A and FIG. 7B, example visualization views illustrate example allocated support seeker organization overview user interfaces in accordance with some embodiments of the present disclosure.

For example, FIG. 7A illustrates an example allocated support seeker organization overview user interface 700A in accordance with some embodiments of the present disclosure.

Similar to those described above, the example allocated support seeker organization overview user interface 700A may be generated in response to an allocated support seeker organization visualization request from a support provider computing device. For example, when a support provider clicks, tabs, or otherwise selects an allocated support seeker organization visualization request user interface element 701 that is rendered on the support provider computing device, the support provider computing device generates and transmits an allocated support seeker organization visualization request to an example integrated service and asset computing platform described herein. In some embodiments, the example integrated service and asset computing platform causes generating the example allocated support seeker organization overview user interface 700A based at least in part on support seeker data objects, similar to various examples described herein.

In the example shown in FIG. 7A, the example allocated support seeker organization overview user interface 700A comprises an allocated organization tabular user interface component 703.

In some embodiments, the allocated organization tabular user interface component 703 is displayed on a predominant portion of the example allocated support seeker organization overview user interface 700A. In some embodiments, the allocated organization tabular user interface component 703 comprises a user interface element in a tabular form that may display context information associated with the organizations that are allocated to the support provider. In some embodiments, the allocated organization tabular user interface component 703 may be generated based on support seeker context metadata associated with one or more support seeker data objects that are accessed based on the support provider identifying metadata from the allocated support seeker organization visualization request, similar to various examples described herein.

In the example shown in FIG. 7A, the allocated organization tabular user interface component 703 comprises an allocated organization name metadata portion 705 and an allocated organization domain metadata portion 707.

In some embodiments, the allocated organization name metadata portion 705 may comprise a list of organization names associated with the organizations that are allocated to the support provider to provide information technology related support. In some embodiments, the allocated organization name metadata portion 705 may be generated based on the organization context metadata associated with the support seeker data objects. In some embodiments, the allocated organization domain metadata portion 707 may comprise a list of domains associated with the organizations that are allocated to the support provider to provide information technology related support. In some embodiments, the allocated organization domain metadata portion 707 may be generated based on the organization context metadata associated with the support seeker data objects. In some embodiments, each of the organization names in the allocated organization name metadata portion 705 correlates to one of the domains in the allocated organization domain metadata portion 707.

As described above, the example allocated support seeker organization overview user interface illustrated in FIG. 7A provides rich contextual data (such as, but not limited to, organization name information, organization domain information, and/or organization contact information) associated with support seekers to support providers, thereby improving speed and usability of integrated service and asset computing platforms.

While the example shown in FIG. 7A illustrates example metadata portions associated with an example allocated support seeker organization overview user interface, it is noted that the scope of the present disclosure is not limited to the example shown in FIG. 7A. In some embodiments, an example allocated support seeker organization overview user interface may comprise one or more additional and/or alternative metadata portions, and may display additional and/or alternative support seeker context metadata associated with organizations that are allocated to a support provider. For example, the allocated organization tabular user interface component may comprise an allocated organization contact metadata portion that is generated based on the organization context metadata associated with the support seeker data objects and displays contact information corresponding to each of the organizations.

In some embodiments, when a support provider clicks, tabs, or otherwise selects an organization name on the example allocated support seeker organization overview user interface 700A (for example, organization name 709 in the allocated organization name metadata portion 705 shown in FIG. 7A) that is rendered on the support provider computing device, the support provider computing device generates and transmits an allocated organization context detail visualization request to the example integrated service and asset computing platform. In some embodiments, an allocated organization context detail visualization request refers to a request to generate an allocated organization context detail user interface. In some embodiments, in response to receiving the allocated organization context detail visualization request, the example integrated service and asset computing platform causes generating an allocated organization context detail user interface on the support provider computing device. Referring now to FIG. 7B, an example allocated organization context detail user interface 700B in accordance with some embodiments of the present disclosure is illustrated.

In some embodiments, the allocated organization context detail visualization request comprises support seeker identifying metadata that uniquely identifies a support seeker of the example integrated service and asset computing platform (for example, the organization that the support provider selects on the example allocated support seeker organization overview user interface 700A). In some embodiments, a processing circuitry (such as, but not limited to, the processor 305 of the apparatus 300 described in connection with at least FIG. 1 and FIG. 3, and/or the processor 206 of the apparatus 200 described in connection with at least FIG. 1 and FIG. 2) accesses a support seeker data object based on the support seeker identifying metadata, similar to the examples described herein.

In some embodiments, the allocated organization context detail user interface 700B may comprise various metadata portions. In the example shown in FIG. 7B, the allocated organization context detail user interface 700B comprises a support seeker organization name metadata portion 711, a support seeker organization details metadata portion 713, a support seeker organization ticket metadata portion 715, and a support seeker organization contact metadata portion 717.

In some embodiments, the support seeker organization name metadata portion 711 may be generated based on the organization context metadata associated with the support seeker data object, and may display information such as the name of the organization. In some embodiments, the support seeker organization details metadata portion 713 may be generated based on the organization context metadata associated with the support seeker data object, and may display information such as, but not limited to, the domain of the organization. In some embodiments, the support seeker organization contact metadata portion 717 may be generated based on the organization context metadata associated with the support seeker data object, and may display information such as, but not limited to, contact information of the organization.

In some embodiments, the support seeker organization ticket metadata portion 715 may display information associated with support ticket data objects that are associated with the support seeker organization.

In some embodiments, a processing circuitry may generate the support seeker organization ticket metadata portion 715 based on the work item context metadata associated with the support seeker data object, similar to those described above in connection with at least FIG. 5D.

Additionally, or alternatively, a processing circuitry (such as, but not limited to, the processor 305 of the apparatus 300 described in connection with at least FIG. 1 and FIG. 3, and/or the processor 206 of the apparatus 200 described in connection with at least FIG. 1 and FIG. 2) may traverse support ticket data objects stored in the one or more data storage devices of the integrated service and asset computing platform (for example, in the one or more data storage devices 109 in the example integrated service and asset computing platform 105 described above in connection with FIG. 1) based on support seeker identifying metadata from the allocated organization context detail visualization request, and identifies one or more support ticket data objects that comprise metadata matching the support seeker identifying metadata. In some embodiments, the processing circuitry may cause rendering the support seeker organization ticket metadata portion 715 based at least in part on the identified one or more support ticket data objects.

As described above, the example allocated organization context detail user interface illustrated in FIG. 7B provides rich contextual data (such as, but not limited to, organization name information, organization details information, organization ticket information, and organization contact information) associated with support seekers to support providers, thereby improving speed and usability of integrated service and asset computing platforms.

While the example shown in FIG. 7B illustrates example metadata portions associated with an example allocated organization context detail user interface, it is noted that the scope of the present disclosure is not limited to the example shown in FIG. 7B. In some embodiments, an example allocated organization context detail user interface may comprise one or more additional and/or alternative metadata portions, and may display additional and/or alternative support seeker context metadata associated with an organization that is allocated to a support provider.

### Example Allocated Support Seeker Contact User Interfaces

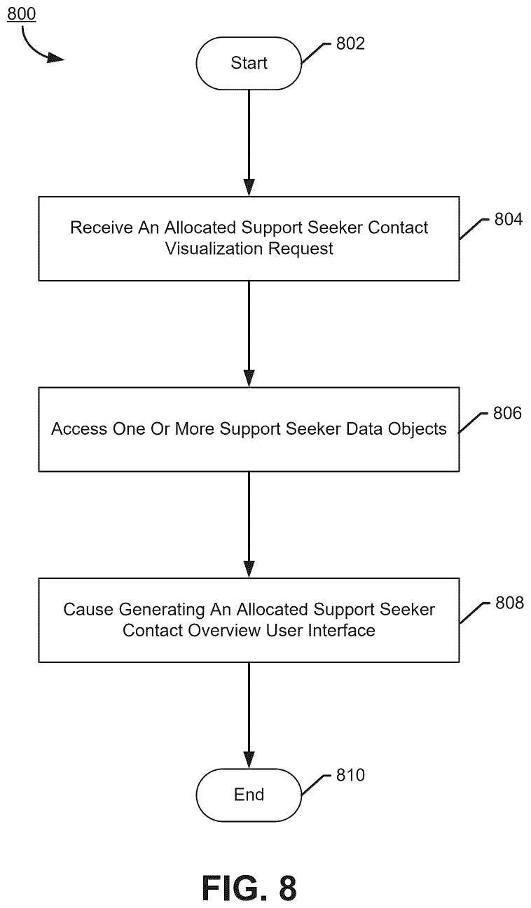

Referring now to FIG. 8, an example flow diagram illustrating example methods associated with generating example allocated support seeker contact overview user interfaces in accordance with some embodiments of the present disclosure is provided.

For example, example methods illustrated in FIG. 8 resolve technical issues associated with integrated service and asset computing platforms and improve the functioning of integrated service and asset computing platform by generating allocated support seeker contact overview user interfaces based on support seeker data objects that are stored within the example integrated service and asset computing platform. As such, example allocated support seeker contact overview user interfaces in accordance with example methods illustrated in FIG. 8 provide rich contextual data associated with support seekers to support providers while such example methods improve speed of rendering such user interfaces and usability of integrated service and asset computing platforms.

In the example shown in FIG. 8, an example method 800 starts at step/operation 802 and then proceeds to step/operation 804. At step/operation 804, in some embodiments, a processing circuitry (such as, but not limited to, the processor 305 of the apparatus 300 described in connection with at least FIG. 1 and FIG. 3, and/or the processor 206 of the apparatus 200 described in connection with at least FIG. 1 and FIG. 2) receives an allocated support seeker contact visualization request.

In some embodiments, the processing circuitry receives an allocated support seeker contact visualization request from a support provider computing device. In some embodiments, the allocated support seeker contact visualization request comprises support provider identifying metadata.

For example, the allocated support seeker contact visualization request may be generated by a support provider computing device (for example, the support provider computing device 101A in FIG. 1) that is associated with a support provider who is a customer support agent. As an example, the customer support agent may be assigned or allocated to manage, track, and/or resolve information technology related issues from various support seekers of the integrated service and asset computing platform that are associated with various individual contacts (for example, individual support seekers, users from organizational support seekers, and/or the like). In such an example, the customer support agent may operate the support provider computing device 101A to generate the allocated support seeker contact visualization request to request the example integrated service and asset computing platform 105 to generate an allocated support seeker contact overview user interface on the support provider computing device 101A, which visualizes information and content associated with contacts that the customer support agent have been allocated to. Continuing in this example, the support provider computing device 101A may generate the allocated support seeker contact visualization request and transmit the allocated support seeker contact visualization request to the integrated service and asset computing platform 105.

Continuing in the example above, the allocated support seeker contact visualization request may comprise support provider identifying metadata that uniquely identifies the customer support agent. In such an example, in response to receiving the allocated support seeker contact visualization request, one or more network computing devices in the integrated service and asset computing platform (for example, the one or more network computing devices 107 in the example integrated service and asset computing platform 105 in FIG. 1) may parse the support provider identifying metadata from the allocated support seeker contact visualization request.

Referring back to FIG. 8, subsequent and/or in response to step/operation 804, the example method 800 proceeds to step/operation 806. At step/operation 806, in some embodiments, a processing circuitry (such as, but not limited to, the processor 305 of the apparatus 300 described in connection with at least FIG. 1 and FIG. 3, and/or the processor 206 of the apparatus 200 described in connection with at least FIG. 1 and FIG. 2) accesses one or more support seeker data objects.

In some embodiments, the processing circuitry accesses one or more support seeker data objects from an example integrated service and asset computing platform based at least in part on the support provider identifying metadata in the allocated support seeker contact visualization request received at step/operation 804.

As described above, in some embodiments, an example support seeker data object may comprise support provider identifying metadata that identifies one or more support providers who provide information technology related support to the support seeker associated with the example support seeker data object. In some embodiments, the processing circuitry accesses one or more support seeker data objects from an example integrated service and asset computing platform based at least in part on the support provider identifying metadata in the allocated support seeker contact visualization request received at step/operation 804.

Continuing in the example above, one or more network computing devices in the integrated service and asset computing platform (for example, the one or more network computing devices 107 in the example integrated service and asset computing platform 105 described above in connection with FIG. 1) may traverse support seeker data objects stored in the one or more data storage devices of the integrated service and asset computing platform (for example, in the one or more data storage devices 109 in the example integrated service and asset computing platform 105 described above in connection with FIG. 1) based on the support provider identifying metadata that is associated with the allocated support seeker contact visualization request received at step/operation 804. Through traversing, the one or more network computing devices 107 in the integrated service and asset computing platform 105 may identify one or more support seeker data objects that comprise metadata matching the support provider identifying metadata. In such an example, the identified one or more support seeker data objects comprise data, information and content associated with support seekers that are allocated to the customer support agent.

In some embodiments, the support seeker data object is stored in an asset-based data tracking system of the example integrated service and asset computing platform. In such embodiments, the processing circuitry accesses the support seeker data object from the asset-based data tracking system. Additional details associated with the asset-based data tracking system are described herein, including, but not limited to, in connection with at least FIG. 10A to FIG. 10D.

Referring back to FIG. 8, subsequent and/or in response to step/operation 806, the example method 800 proceeds to step/operation 808. At step/operation 808, in some embodiments, a processing circuitry (such as, but not limited to, the processor 305 of the apparatus 300 described in connection with at least FIG. 1 and FIG. 3, and/or the processor 206 of the apparatus 200 described in connection with at least FIG. 1 and FIG. 2) causes generating an allocated support seeker contact overview user interface.

In some embodiments, the processing circuitry causes generating the allocated support seeker contact overview user interface on the support provider computing device based at least in part on the one or more support seeker data objects accessed at step/operation 806.

Continuing from the example above, one or more network computing devices in the integrated service and asset computing platform (for example, the one or more network computing devices 107 in the example integrated service and asset computing platform 105 described above in connection with FIG. 1) may cause the support provider computing device 101A to generate an allocated support seeker contact overview user interface that comprises an allocated contact tabular user interface element. For example, the allocated contact tabular user interface element may comprise a table rendering that comprises an allocated contact name metadata portion (which displays names of contacts that are allocated to the customer support agent to provide information technology related support to) and an allocated contact email metadata portion (which displays email addresses of contacts that are allocated to the customer support agent to provide information technology related support to).

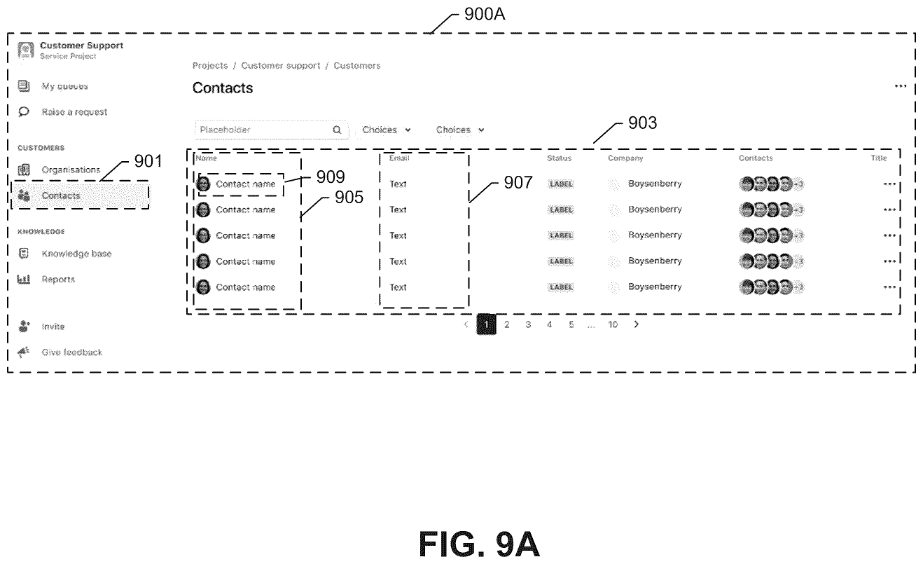

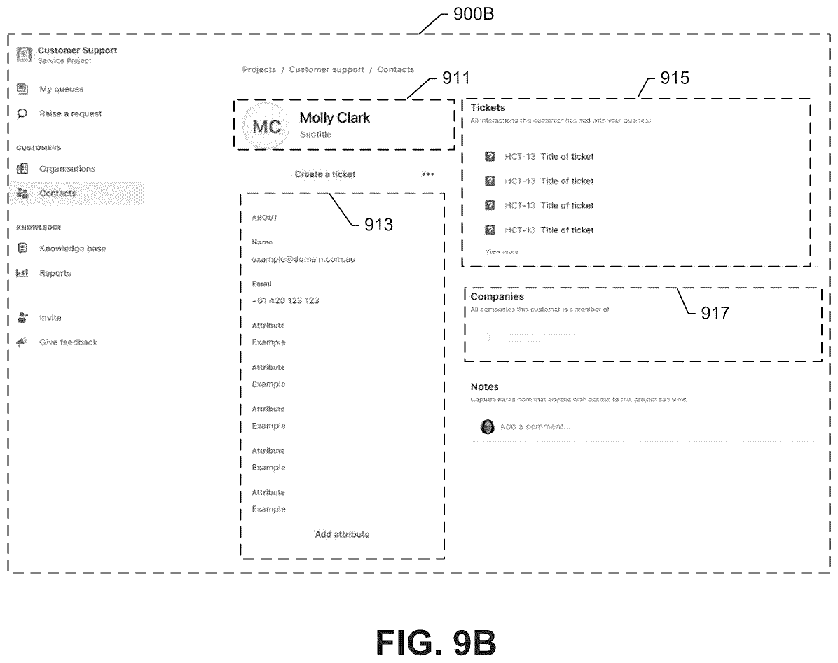

Additional details and examples associated with example allocated organization tabular user interfaces are described herein, including, but not limited to, those described in connection with at least FIG. 9A and FIG. 9B.

Referring back to FIG. 8, subsequent and/or in response to step/operation 808, the example method 800 proceeds to step/operation 810 and ends.

Referring now to FIG. 9A and FIG. 9B, example visualization views illustrate example allocated support seeker organization overview user interfaces in accordance with some embodiments of the present disclosure.

For example, FIG. 9A illustrates an example allocated support seeker contact overview user interface 900A in accordance with some embodiments of the present disclosure.

Similar to those described above, the example allocated support seeker contact overview user interface 900A may be generated in response to an allocated support seeker contact visualization request from a support provider computing device. For example, when a support provider clicks, tabs, or otherwise selects an allocated support seeker contact visualization request user interface element 901 that is rendered on the support provider computing device, the support provider computing device generates and transmits an allocated support seeker contact visualization request to an example integrated service and asset computing platform described herein. In some embodiments, the example integrated service and asset computing platform causes generating the example allocated support seeker contact overview user interface 900A based at least in part on support seeker data objects, similar to various examples described herein.

In the example shown in FIG. 9A, the example allocated support seeker contact overview user interface 900A comprises an allocated contact tabular user interface component 903.

In some embodiments, the allocated contact tabular user interface component 903 is displayed on a predominant portion of the example allocated support seeker contact overview user interface 900A. In some embodiments, the allocated contact tabular user interface component 903 comprises a user interface element in a tabular form that may display information associated with the contacts that are allocated to the support provider. In some embodiments, the allocated contact tabular user interface component 903 may be generated based on support seeker context metadata associated with one or more support seeker data objects that are accessed based on the support provider identifying metadata from the allocated support seeker contact visualization request, similar to various examples described herein.

In the example shown in FIG. 9A, the allocated contact tabular user interface component 903 comprises an allocated contact name metadata portion 905 and an allocated contact email metadata portion 907.

In some embodiments, the allocated contact name metadata portion 905 may comprise a list of contact names associated with the contacts that are allocated to the support provider to provide information technology related support. In some embodiments, the allocated contact name metadata portion 905 may be generated based on the customer context metadata associated with the support seeker data objects. In some embodiments the allocated contact email metadata portion 907 may comprise a list of email addresses associated with the contacts that are allocated to the support provider to provide information technology related support. In some embodiments, the allocated contact email metadata portion 907 may be generated based on the customer context metadata associated with the support seeker data objects. In some embodiments, each of the contact names in the allocated contact name metadata portion 905 correlates to one of the email addresses in the allocated contact email metadata portion 907.

As described above, the example allocated support seeker contact overview user interface illustrated in FIG. 9A provides rich contextual data (such as, but not limited to, contact name information and contact email information) associated with support seekers to support providers, thereby improving speed and usability of integrated service and asset computing platforms.

While the example shown in FIG. 9A illustrates example metadata portions associated with an example allocated support seeker contact overview user interface, it is noted that the scope of the present disclosure is not limited to the example shown in FIG. 9A. In some embodiments, an example allocated support seeker contact overview user interface may comprise one or more additional and/or alternative metadata portions, and may display additional and/or alternative support seeker context metadata associated with contacts that are allocated to a support provider. For example, the allocated organization tabular user interface component may comprise an allocated contact organization metadata portion that is generated based on the organization context metadata associated with the support seeker data objects and displays organization information corresponding to each of the contacts. Additionally, or alternatively, the allocated organization tabular user interface component may comprise an allocated organization contact metadata portion, similar to the example described in connection with at least FIG. 7A.

In some embodiments, when a support provider clicks, tabs, or otherwise selects an contact name on the example allocated support seeker contact overview user interface 900A (for example, contact name 909 in the allocated contact name metadata portion 905 shown in FIG. 9A) that is rendered on the support provider computing device, the support provider computing device generates and transmits an allocated contact context detail visualization request to the example integrated service and asset computing platform. In some embodiments, an allocated contact context detail visualization request refers to a request to generate an allocated contact context detail user interface. In some embodiments, in response to receiving the allocated contact context detail visualization request, the example integrated service and asset computing platform causes generating an allocated contact context detail user interface on the support provider computing device. Referring now to FIG. 9B, an example allocated contact context detail user interface 900B in accordance with some embodiments of the present disclosure is illustrated.

In some embodiments, the allocated contact context detail visualization request comprises support seeker identifying metadata that uniquely identifies a support seeker of the example integrated service and asset computing platform (for example, the support seeker that the support provider selects on the example allocated support seeker contact overview user interface 900A). In some embodiments, a processing circuitry (such as, but not limited to, the processor 305 of the apparatus 300 described in connection with at least FIG. 1 and FIG. 3, and/or the processor 206 of the apparatus 200 described in connection with at least FIG. 1 and FIG. 2) accesses a support seeker data object based on the support seeker identifying metadata, similar to the examples described herein.

In some embodiments, the allocated contact context detail user interface 900B may comprise various metadata portions. In the example shown in FIG. 9B, the allocated contact context detail user interface 900B comprises a support seeker contact name metadata portion 911, a support seeker contact details metadata portion 913, a support seeker contact ticket metadata portion 915, and a support seeker contact organization metadata portion 917.

In some embodiments, the support seeker contact name metadata portion 911 may be generated based on the customer context metadata associated with the support seeker data object, and may display information such as the name of the contact. In some embodiments, the support seeker contact details metadata portion 913 may be generated based on the customer context metadata associated with the support seeker data object, and may display information such as, but not limited to, the email address of the contact. In some embodiments, the support seeker contact organization metadata portion 917 may be generated based on the organization context metadata associated with the support seeker data object, and may display information such as organization(s) associated with the contact.

In some embodiments, the support seeker contact ticket metadata portion 915 may display information associated with support ticket data objects that are associated with the support seeker contact.

In some embodiments, a processing circuitry may generate the support seeker contact ticket metadata portion 915 based on the work item context metadata associated with the support seeker data object, similar to those described above in connection with at least FIG. 5D.

Additionally, or alternatively, a processing circuitry (such as, but not limited to, the processor 305 of the apparatus 300 described in connection with at least FIG. 1 and FIG. 3, and/or the processor 206 of the apparatus 200 described in connection with at least FIG. 1 and FIG. 2) may traverse support ticket data objects stored in the one or more data storage devices of the integrated service and asset computing platform (for example, in the one or more data storage devices 109 in the example integrated service and asset computing platform 105 described above in connection with FIG. 1) based on support seeker identifying metadata from the allocated contact context detail visualization request, and identifies one or more support ticket data objects that comprise metadata matching the support seeker identifying metadata. In some embodiments, the processing circuitry may cause rendering the support seeker contact ticket metadata portion 915 based at least in part on the identified one or more support ticket data objects.

As described above, the example allocated contact context detail user interface illustrated in FIG. 9B provides rich contextual data (such as, but not limited to, contact name information, contact details information, contact ticket information, and contact organization information) associated with support seekers to support providers, thereby overcoming problems in user interfaces described above and improving speed and usability of integrated service and asset computing platforms.

While the example shown in FIG. 9B illustrates example metadata portions associated with an example allocated contact context detail user interface, it is noted that the scope of the present disclosure is not limited to the example shown in FIG. 9B. In some embodiments, an example allocated contact context detail user interface may comprise one or more additional and/or alternative metadata portions, and may display additional and/or alternative support seeker context metadata associated with a contact that is allocated to a support provider.

### Example System Schemas for Implementing Embodiments of the Present Disclosure

Referring now to FIG. 10A, FIG. 10B, FIG. 10C, and FIG. 10D, example system schema diagrams illustrate example data communications in example integrated service and asset computing platforms in accordance with some embodiments of the present disclosure.

In some embodiments, an example integrated service and asset computing platform may comprise one or more systems including, but not limited to, one or more ticket-based service managing systems, one or more asset-based data tracking systems, and/or the like.

In some embodiments, the term “ticket-based service managing system” refers to a computing system that generates and stores ticket data objects that represent data and information associated with information technology related issues that are encountered by support seekers of an integrated service and asset computing platform. In some embodiments, an example ticket-based service managing system may comprise one or more network computing devices and one or more data storage devices, similar to the examples described above in connection with at least FIG. 1.

In some embodiments, the term “asset-based data tracking system” refers to a computing system that generates and stores asset data objects that represent data and information associated with information technology related assets associated with support seekers of the integrated service and asset computing platform, as well as support seeker data objects that describes information and content associated with support seekers (including, but not limited to, support seeker context metadata) of the integrated service and asset computing platform. In some embodiments, an example asset-based data tracking system may comprise one or more network computing devices and one or more data storage devices, similar to the examples described above in connection with at least FIG. 1.

As described above, an example integrated service and asset computing platform in accordance with some embodiments of the present disclosure may receive visualization requests (such as, but not limited to, contextualized support ticket visualization requests, allocated support seeker organization visualization requests, and allocated support seeker contact visualization requests) from support provider computing devices. In some embodiments, the example integrated service and asset computing platform access support seeker data objects that are stored in the asset-based data tracking system and cause generating contextualized user interfaces (such as, but not limited to, contextualized support ticket user interfaces, allocated support seeker organization overview user interfaces, and allocated support seeker contact overview user interfaces) based on the support seeker data objects. FIG. 10A, FIG. 10B, FIG. 10C, and FIG. 10D illustrate example data communications between the ticket-based service managing system and the asset-based data tracking system of an example integrated service and asset computing platform for generating contextualized user interfaces (such as, but not limited to, contextualized support ticket user interfaces, allocated support seeker organization overview user interfaces, and allocated support seeker contact overview user interfaces).

Referring now to FIG. 10A, an example system schema diagram 1000A illustrates an example support provider computing device 1002 electronically communicates with an example integrated service and asset computing platform 1004A. For example, the example support provider computing device 1002 may generate and transmits visualization requests (such as, but not limited to, contextualized support ticket visualization requests, allocated support seeker organization visualization requests, and allocated support seeker contact visualization requests) to the example integrated service and asset computing platform 1004A.

In the example shown in FIG. 10A, the example integrated service and asset computing platform 1004A comprises a ticket-based service managing system 1006 and an asset-based data tracking system 1008.

FIG. 10A illustrates various logic layers associated with the ticket-based service managing system 1006 including, but not limited to, the application programming interface (API) layer 1010, the service layer 1012, the manager layer 1014, and the store layer 1016.

In some embodiments, the API layer 1010 of the ticket-based service managing system 1006 acts as an interface that enables the example support provider computing device 1002 to interact with the example integrated service and asset computing platform 1004A. For example, the API layer 1010 comprises APIs such as, but not limited to, public APIs, internal APIs, and/or other random APIs. In some embodiments, the example support provider computing device 1002 formats the visualization requests (such as, but not limited to, contextualized support ticket visualization requests, allocated support seeker organization visualization requests, and allocated support seeker contact visualization requests) based on available APIs in the API layer 1010.

In some embodiments, the visualization requests at the API layer 1010 of the ticket-based service managing system 1006 forwards the visualization requests (such as, but not limited to, contextualized support ticket visualization requests, allocated support seeker organization visualization requests, and allocated support seeker contact visualization requests) to the service layer 1012. In some embodiments, the service layer 1012 provides operational logics and correlates server responses to the visualization requests. For example, the service layer 1012 may encapsulate various data communication workflows of the integrated service and asset computing platform 1004A and provide guidance on correct execution of computing logic.

In some embodiments, the manager layer 1014 manages various life cycles of operational logics in the integrated service and asset computing platform 1004A, as well as computing resources of the integrated service and asset computing platform 1004A.

In some embodiments, the store layer 1016 provides an interface between the ticket-based service managing system 1006 and one or more data storage devices (such as, but not limited to, the data storage device 1018 shown in FIG. 10A).

In the example shown in FIG. 10A, the example system schema diagram 1000A illustrates an example method of synchronized access to support seeker data objects stored in the asset-based data tracking system 1008. For example, upon receiving visualization requests (such as, but not limited to, contextualized support ticket visualization requests, allocated support seeker organization visualization requests, and allocated support seeker contact visualization requests) from the example support provider computing device 1002, the service layer 1012 requests accesses to related support seeker data objects in the asset-based data tracking system 1008, illustrating a straight-forward implementation that provides technical benefits and advantages such as, but not limited to, consistent data communications without added complexity.

Referring now to FIG. 10B, an example system schema diagram 1000B illustrates an example support provider computing device 1002 electronically communicates with an example integrated service and asset computing platform 1004B. Similar to the examples shown in FIG. 10A, the example support provider computing device 1002 may generate and transmits visualization requests (such as, but not limited to, contextualized support ticket visualization requests, allocated support seeker organization visualization requests, and allocated support seeker contact visualization requests) to the example integrated service and asset computing platform 1004B.

In the example shown in FIG. 10B, the example integrated service and asset computing platform 1004B comprises a ticket-based service managing system 1006 and an asset-based data tracking system 1008. Similar to the example shown in FIG. 10A, FIG. 10B illustrates various logic layers associated with the ticket-based service managing system 1006 including, but not limited to, the API layer 1010, the service layer 1012, the manager layer 1014, and the store layer 1016.

In contrast with the example shown in FIG. 10A, the example integrated service and asset computing platform 1004B additionally comprises an asynchronous event bus 1020 and an asset management service 1022. In some embodiments, the asynchronous event bus 1020 provides service-to-service data communications within the example integrated service and asset computing platform 1004B in an asynchronous manner. For example, upon receiving visualization requests (such as, but not limited to, contextualized support ticket visualization requests, allocated support seeker organization visualization requests, and allocated support seeker contact visualization requests) from the example support provider computing device 1002, the service layer 1012 transmits requests to access related support seeker data objects in the asset-based data tracking system 1008 to the asynchronous event bus 1020. In such an example, the asynchronous event bus 1020 generates a queue of requests to access related support seeker data objects, and communicates each request to access related support seeker data objects to the asset-based data tracking system 1008 through the asset management service 1022. In some embodiments, the asynchronous event bus 1020 is configured to confirm the delivery of requests to access related support seeker data objects. If the delivery is not confirmed, the asynchronous event bus 1020 generates an error message. As such, the example system schema diagram 1000B provides technical benefits and advantages such as, but not limited to, improved consistency in handling request to access related support seeker data objects between the ticket-based service managing system 1006 and the asset-based data tracking system 1008.

Referring now to FIG. 10C, an example system schema diagram 1000C illustrates an example support provider computing device 1002 electronically communicates with an example integrated service and asset computing platform 1004C. Similar to the examples shown in FIG. 10A, the example support provider computing device 1002 may generate and transmits visualization requests (such as, but not limited to, contextualized support ticket visualization requests, allocated support seeker organization visualization requests, and allocated support seeker contact visualization requests) to the example integrated service and asset computing platform 1004C.

In the example shown in FIG. 10C, the example integrated service and asset computing platform 1004C comprises a ticket-based service managing system 1006 and an asset-based data tracking system 1008. Similar to the example shown in FIG. 10A, FIG. 10C illustrates various logic layers associated with the ticket-based service managing system 1006 including, but not limited to, the API layer 1010, the service layer 1012, the manager layer 1014, and the store layer 1016.

In contrast with the example shown in FIG. 10A, the example integrated service and asset computing platform 1004B additionally comprises a GraphQL gateway 1024, a GraphQL layer 1026, and an asset management service 1028. In such an example, the example integrated service and asset computing platform 1004C may still receive requests from the example support provider computing device 1002 through the API layer 1010 of the ticket-based service managing system 1006. Additionally, the GraphQL gateway 1024 functions as a visualization request gateway that provides one or more additional interfaces (for example, APIs) for receiving visualization requests (such as, but not limited to, contextualized support ticket visualization requests, allocated support seeker organization visualization requests, and allocated support seeker contact visualization requests) from the example support provider computing device 1002. Upon receiving the visualization requests, the GraphQL Gateway 1024 forwards the visualization requests to the GraphQL layer 1026, which functions as an interface to the asset management service 1028. In some embodiments, the asset management service 1028 may access support seeker data objects from the asset-based data tracking system 1008, and may forward requests to access support ticket data objects to the ticket-based service managing system 1006 through the API layer 1010. As such, the example system schema diagram 1000C provides technical benefits and advantages such as, but not limited to, improved access to support seeker data objects through additional GraphQL.

Referring now to FIG. 10D, an example system schema diagram 1000D illustrates an example support provider computing device 1002 electronically communicates with an example integrated service and asset computing platform 1004D. Similar to the examples shown in FIG. 10A, the example support provider computing device 1002 may generate and transmits visualization requests (such as, but not limited to, contextualized support ticket visualization requests, allocated support seeker organization visualization requests, and allocated support seeker contact visualization requests) to the example integrated service and asset computing platform 1004D.

In the example shown in FIG. 10D, the example integrated service and asset computing platform 1004D comprises a ticket-based service managing system 1006 and an asset-based data tracking system 1008. Similar to the example shown in FIG. 10A, FIG. 10D illustrates various logic layers associated with the ticket-based service managing system 1006 including, but not limited to, the API layer 1010, the service layer 1012, the manager layer 1014, and the store layer 1016.

In contrast with the example shown in FIG. 10A, the example integrated service and asset computing platform 1004D additionally comprises an asset management service 1030. In some embodiments, upon receiving visualization requests (such as, but not limited to, contextualized support ticket visualization requests, allocated support seeker organization visualization requests, and allocated support seeker contact visualization requests) from the example support provider computing device 1002, the API layer 1010 requests access to related support seeker data objects through the asset management service 1030. In some embodiments, the asset management service 1030 controls access to the support seeker data objects in the asset-based data tracking system 1008. As such, the example system schema diagram 1000D provides technical benefits and advantages such as, but not limited to, improved access to support seeker data objects with high consistency.

While the description above provides example system schema diagrams illustrating example data communications in example integrated service and asset computing platforms, it is noted that the scope of the present disclosure is not limited to the description above. In some examples, an example integrated service and asset computing platform may comprise one or more additional and/or alternative elements that facilitate data communications.

### Additional Implementation Details

Although example processing systems have been described above, implementations of the subject matter and the functional operations described herein can be implemented in other types of digital electronic circuitry, or in computer software, firmware, or hardware, including the structures disclosed in this specification and their structural equivalents, or in combinations of one or more of them.

Embodiments of the subject matter and the operations described herein can be implemented in digital electronic circuitry, or in computer software, firmware, or hardware, including the structures disclosed in this specification and their structural equivalents, or in combinations of one or more of them. Embodiments of the subject matter described herein can be implemented as one or more computer programs, i.e., one or more modules of computer program instructions, encoded on computer-readable storage medium for execution by, or to control the operation of, information/data processing apparatus. A computer-readable storage medium can be, or be included in, a computer-readable storage device, a computer-readable storage substrate, a random or serial access memory array or device, or a combination of one or more of them. The computer-readable storage medium can also be, or be included in, one or more separate physical components or media (e.g., multiple CDs, disks, or other storage devices).

The operations described herein can be implemented as operations performed by an information/data processing apparatus on information/data stored on one or more computer-readable storage devices or received from other sources.

The term “apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (Application Specific Integrated Circuit). The apparatus can also include, in addition to hardware, code that creates an execution environment for the computer program in question, e.g., code that constitutes processor firmware, a protocol stack, a data object repository management system, an operating system, a cross-platform runtime environment, a virtual machine, or a combination of one or more of them. The apparatus and execution environment can realize various different computing model infrastructures, such as web services, distributed computing, and grid computing infrastructures.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or information/data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described herein can be performed by one or more programmable processors executing one or more computer programs to perform actions by operating on input information/data and generating output. Processors suitable for the execution of a computer program include, by way of example, both general and special purpose microprocessors, and any one or more processors of any kind of digital computer. Generally, a processor will receive instructions and information/data from a read-only memory, a random-access memory, or both. The essential elements of a computer are a processor for performing actions in accordance with instructions and one or more memory devices for storing instructions and data. Generally, a computer will also include, or be operatively coupled to receive information/data from or transfer information/data to, or both, one or more mass storage devices for storing data, e.g., magnetic, magneto-optical disks, or optical disks. However, a computer needs not have such devices. Devices suitable for storing computer program instructions and information/data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described herein can be implemented on a computer having a display device, e.g., an LCD monitor, for displaying information/data to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's user computing device in response to requests received from the web browser.

Embodiments of the subject matter described herein can be implemented in a computing system that includes a back-end component, e.g., as an information/data server, or that includes a middleware component, e.g., an application server, or that includes a front-end component, e.g., a user computing device having a graphical user interface or a web browser through which a user can interact with an implementation of the subject matter described herein, or any combination of one or more such back-end, middleware, or front-end components. The components of the system can be interconnected by any form or medium of digital information/data communication, e.g., a communication network. Examples of communication networks include a local area network (“LAN”) and a wide area network (“WAN”), an inter-network (e.g., the Internet), and peer-to-peer networks (e.g., ad hoc peer-to-peer networks).

The computing system can include clients and servers. A client and server are generally remote from each other and typically interact through a communication network. The relationship of client and server arises by virtue of computer programs running on the respective computers and having a client-server relationship to each other. In some embodiments, a server transmits information/data (e.g., an HTML (Hypertext Markup Language) page) to a user computing device (e.g., for purposes of displaying information/data to and receiving user input from a user interacting with the user computing device). Information/data generated at the user computing device (e.g., a result of the user interaction) can be received from the user computing device at the server.

While this specification contains many specific implementation details, these should not be construed as limitations on the scope of any disclosures or of what may be claimed, but rather as description of features specific to particular embodiments of particular disclosures. Certain features that are described herein in the context of separate embodiments can also be implemented in combination in a single embodiment. Conversely, various features that are described in the context of a single embodiment can also be implemented in multiple embodiments separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

Similarly, while operations are depicted in the drawings in a particular order, this should not be understood as requiring that such operations be performed in the particular order shown or in sequential order, or that all illustrated operations be performed, to achieve desirable results, unless described otherwise. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the subject matter have been described. Other embodiments are within the scope of the following claims. In some cases, the actions recited in the claims can be performed in a different order and still achieve desirable results. In addition, the processes depicted in the accompanying figures do not necessarily require the particular order shown, or sequential order, to achieve desirable results, unless described otherwise. In certain implementations, multitasking and parallel processing may be advantageous.

Many modifications and other embodiments of the disclosures set forth herein will come to mind to one skilled in the art to which these disclosures pertain having the benefit of the teachings presented in the foregoing description and the associated drawings. Therefore, it is to be understood that the disclosures are not to be limited to the specific embodiments disclosed and that modifications and other embodiments are intended to be included within the scope of the appended claims. Although specific terms are employed herein, they are used in a generic and descriptive sense only and not for purposes of limitation, unless described otherwise.

1. An apparatus comprising at least one processor and at least one non-transitory memory comprising program code, the at least one non-transitory memory and the program code configured to, with the at least one processor, cause the apparatus to at least:
receive an allocated support seeker visualization request from a support provider computing device, wherein the allocated support seeker visualization request comprises at least one of an allocated support seeker organization visualization request or an allocated support seeker contact visualization request;
access one or more support seeker data objects from an asset-based data tracking system based on the allocated support seeker visualization request, wherein each of the one or more support seeker data objects comprises support seeker context metadata; and
cause generating an allocated support seeker overview user interface based at least in part on the support seeker context metadata, wherein the allocated support seeker overview user interface comprises at least one of an allocated support seeker organization overview user interface or an allocated support seeker contact overview user interface.

2. The apparatus of claim 1, wherein the allocated support seeker overview user interface comprises the allocated support seeker organization overview user interface, wherein the allocated support seeker organization overview user interface comprises an allocated organization tabular user interface component.

3. The apparatus of claim 2, wherein the allocated organization tabular user interface component comprises an allocated organization name metadata portion and an allocated organization domain metadata portion.

4. The apparatus of claim 3, wherein the at least one non-transitory memory and the program code are configured to, with the at least one processor, cause the apparatus to:
in response to receiving a user selection input associated with the allocated organization name metadata portion, cause generating an allocated organization context detail user interface.

5. The apparatus of claim 1, wherein the allocated support seeker overview user interface comprises the allocated support seeker contact overview user interface, wherein the allocated support seeker contact overview user interface comprises an allocated contact tabular user interface component.

6. The apparatus of claim 5, wherein the allocated contact tabular user interface component comprises an allocated contact name metadata portion and an allocated contact email metadata portion.

7. The apparatus of claim 6, wherein the at least one non-transitory memory and the program code are configured to, with the at least one processor, cause the apparatus to:
in response to receiving a user selection input associated with the allocated contact name metadata portion, cause generating an allocated contact context detail user interface.

8. A computer-implemented method comprising:
receiving an allocated support seeker visualization request from a support provider computing device, wherein the allocated support seeker visualization request comprises at least one of an allocated support seeker organization visualization request or an allocated support seeker contact visualization request;
accessing one or more support seeker data objects from an asset-based data tracking system based on the allocated support seeker visualization request, wherein each of the one or more support seeker data objects comprises support seeker context metadata; and
causing generating an allocated support seeker overview user interface based at least in part on the support seeker context metadata, wherein the allocated support seeker overview user interface comprises at least one of an allocated support seeker organization overview user interface or an allocated support seeker contact overview user interface.

9. The computer-implemented method of claim 8, wherein the allocated support seeker overview user interface comprises the allocated support seeker organization overview user interface, wherein the allocated support seeker organization overview user interface comprises an allocated organization tabular user interface component.

10. The computer-implemented method of claim 9, wherein the allocated organization tabular user interface component comprises an allocated organization name metadata portion and an allocated organization domain metadata portion.

11. The computer-implemented method of claim 10, further comprising:
in response to receiving a user selection input associated with the allocated organization name metadata portion, causing generating an allocated organization context detail user interface.

12. The computer-implemented method of claim 8, wherein the allocated support seeker overview user interface comprises the allocated support seeker contact overview user interface, wherein the allocated support seeker contact overview user interface comprises an allocated contact tabular user interface component.

13. The computer-implemented method of claim 12, wherein the allocated contact tabular user interface component comprises an allocated contact name metadata portion and an allocated contact email metadata portion.

14. The computer-implemented method of claim 13, further comprising:
in response to receiving a user selection input associated with the allocated contact name metadata portion, causing generating an allocated contact context detail user interface.

15. A computer program product comprising at least one non-transitory computer-readable storage medium having computer-readable program code portions stored therein, the computer-readable program code portions comprising an executable portion configured to:
receive an allocated support seeker visualization request from a support provider computing device, wherein the allocated support seeker visualization request comprises at least one of an allocated support seeker organization visualization request or an allocated support seeker contact visualization request;
access one or more support seeker data objects from an asset-based data tracking system based on the allocated support seeker visualization request, wherein each of the one or more support seeker data objects comprises support seeker context metadata; and
cause generating an allocated support seeker overview user interface based at least in part on the support seeker context metadata, wherein the allocated support seeker overview user interface comprises at least one of an allocated support seeker organization overview user interface or an allocated support seeker contact overview user interface.

16. The computer program product of claim 15, wherein the allocated support seeker overview user interface comprises the allocated support seeker organization overview user interface, wherein the allocated support seeker organization overview user interface comprises an allocated organization tabular user interface component.

17. The computer program product of claim 16, wherein the allocated organization tabular user interface component comprises an allocated organization name metadata portion and an allocated organization domain metadata portion.

18. The computer program product of claim 17, wherein the executable portion is configured to:
in response to receiving a user selection input associated with the allocated organization name metadata portion, cause generating an allocated organization context detail user interface.

19. The computer program product of claim 15, wherein the allocated support seeker overview user interface comprises the allocated support seeker contact overview user interface, wherein the allocated support seeker contact overview user interface comprises an allocated contact tabular user interface component.

20. The computer program product of claim 19, wherein the allocated contact tabular user interface component comprises an allocated contact name metadata portion and an allocated contact email metadata portion.
